(19) United States
(12) Patent Application Publication
(10) Pub. No.: US 2010/0067772 A1
(43) Pub. Date: Mar. 18, 2010

(54) RADIATION IMAGE PROCESSING METHOD, APPARATUS AND PROGRAM

(75) Inventor: Yoshiro Kitamura, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/523,001

(22) PCT Filed: Jan. 11, 2008
(86) PCT No.: PCT/JP2008/050651

§ 371 Date: Jul. 13, 2009

(30) Foreign Application Priority Data
Jan. 12, 2007 (JP) 2007-003975
Jan. 12, 2007 (JP) 2007-003976

(51) Int. Cl. G06K 9/00

(52) U.S. Cl. 382/132

(57) ABSTRACT

A radiation image processing method capable of improving the quality of a radiation image representing a subject without increasing the radiation dose to the subject. Providing, with respect to each of a plurality of subjects of the same type, an input image generated using high and low energy images obtained by radiography and a teacher radiation image having less image quality degradation than the input radiation image and representing the subject with a particular region highlighted; and obtaining a teacher trained filter through training using the input radiation image as input and the teacher radiation image as the teacher. Then, generating a radiation image of the same type as the input radiation image for a given subject, and inputting the radiation image to the teacher trained filter to form a radiation image of the given subject compensated for image quality degradation with the particular region highlighted.

### TECHNICAL FIELD

The present invention relates to a radiation image processing method, apparatus and computer program product for obtaining a radiation image representing a subject by enhancing a particular region of the subject.

### BACKGROUND ART

In medical radiography and the like, a method for obtaining an energy subtraction image is known as described, for example, in Japanese Unexamined Patent Publication No. 3 (1991)-285475, in which a high energy image and a low energy image are obtained by radiography of a subject using radiations having different energy distributions from each other, and a region of the subject showing a particular radiation attenuation coefficient, such as the bone portion or soft tissue portion of the living tissues, is enhanced by performing a weighted subtraction of the high and low energy images. The energy subtraction image is an image formed based on the difference between the high and low energy images.

As for the method for obtaining the high and low energy images, a dual shot radiography in which the high and low energy images are obtained by irradiating two types of radiations having different energy distributions from each other, generated by changing the tube voltage of the radiation source, on the subject at two different timings, a single shot radiography in which the high and low energy images are recorded simultaneously on two storage phosphor sheets with a copper plate sandwiched between them by a single irradiation of radiation on the subject, or the like is known.

The energy subtraction image formed using the high and low energy images is superior to a radiation image (also referred to as “plain radiation image”) obtained by the ordinary radiography (plain radiography) in that it is capable of enhancing the particular region described above, but contains more noise. The plain radiography is radiography that obtains a radiation image of a subject by irradiating one type of radiation on the subject once, without using a plurality of types of radiations having different energy distributions from each other.

The noise in the energy subtraction image is mainly caused by insufficient doses of radiations irradiated when obtaining the high and low energy images.

That is, in medical radiography and the like, it is desirable to reduce the burden on the patient by reducing the radiation dose used for the radiography. For example, in the radiography that requires the ordinary radiography two times (dual shot radiography), if an insufficient dose of radiation is used in either one of the shots, or if radiation images (high and low energy images) obtained by the radiography (single shot radiography) in which the radiation dose is attenuated by the copper plate by absorption are used, the image quality of the energy subtraction image is degraded than that of a plain radiation image obtained by plain radiography.

In either the single shot radiography or dual shot radiography, it is necessary to reduce the radiation dose to the subject in the radiography, if the radiation dose to the subject is reduced in the radiography, the amount of noise in the radiation image obtained by the radiography is increased and the image quality is degraded as described above.

In the mean time, a method for forming a radiation image representing a subject by enhancing the bone portion thereof from a single image obtained by plain radiography is known as described, for example, in U.S. Patent Application Publication No. 20050100208 A1. This method obtains an image which is similar to the bone image of the energy subtraction image without performing radiography using radiations having different energy distributions from each other.

More specifically, the method obtains an image similar to the bone image by the following procedure.

That is, a teacher radiation image of a subject obtained by the radiography of a human chest in which the bone portion is enhanced is formed in advance. Then, a teacher trained filter (filter employing artificial neural networks (ANN)) is obtained by repeating the training so that when a training plain radiation image representing a human chest which is the same type as the subject described above is inputted, a radiation image learned from the teacher image, i.e., a radiation image in which the bone portion is enhanced is outputted. Thereafter, a diagnostic plain radiation image of a human chest is inputted to the teacher trained filter, thereby a diagnostic radiation image of the human chest in which the bone portion is enhanced is obtained.

The method using the teacher trained filter described above, however, would hardly have a sufficient reliability in estimating the bone portion of a subject, and an image component representing the soft tissue portion appears in the image representing the enhanced bone portion as a false image, so that the distinction between the bone portion and the portion other than the bone portion may sometimes become unclear.

That is, when trying to generate a radiation image representing a subject by enhancing a particular region of the subject in the manner as described above, a false image is generated in the radiation image, thereby the image quality would be degraded.

Therefore, there is a demand for a method capable of controlling image quality degradation due to noise, generation of false image, and the like, and obtaining radiation image representing a subject by enhancing a particular region thereof.

The present invention has been developed in view of the circumstances described above, and it is an object of the present invention to provide a radiation image processing method, apparatus, and computer program product capable of improving the quality of a radiation image representing a subject without increasing the radiation dose to the subject.

### DISCLOSURE OF THE INVENTION

A first radiation image processing method of the present invention is a method including the steps of:

providing, with respect to each of a plurality of subjects of the same type, an input radiation image constituted by any one of (i) a high energy image and a low energy image obtained by radiography of each subject with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images;

providing, with respect to each of the subjects, a teacher radiation image, obtained by radiography of each subject, having less image quality degradation than the input radiation image of the subject and representing the subject with a particular region thereof highlighted;

obtaining a teacher trained filter through training using each input radiation image representing each subject as input and the teacher radiation image corresponding to the subject as the teacher so that a radiation image of the subject compensated for image quality degradation with the particular region thereof highlighted is outputted;

obtaining, thereafter, a radiation image of the same type as the input radiation image for a given subject of the same type as the subjects; and

inputting the radiation image of the given subject to the teacher trained filter to form a radiation image of the given subject compensated for image quality degradation with a region thereof corresponding to the particular region highlighted.

Preferably, the radiation dose used in the radiography for generating the teacher radiation image is greater than the radiation dose used in the radiography for generating the input radiation image.

The teacher radiation image may be a so-called energy subtraction image formed by a weighted subtraction using a high energy image and a low energy image obtained by radiography with radiations having different energy distributions from each other.

The particular region may be a region having a particular radiation attenuation coefficient different from that of the other region.

The subject may be a living tissue and the particular region may be a bone portion or a soft tissue portion of the living tissue.

The particular region may be a region of the subject that changed its position between the high energy image and low energy image.

The particular region may be a bone portion, and a soft tissue portion of the given subject may be generated by subtracting the radiation image of the given subject compensated for image quality degradation with the bone portion of the given subject highlighted formed by the radiation image processing method from the high energy image or low energy image representing the given subject.

The particular region may be noise, and the radiation image of the given subject compensated for image quality degradation with the noise highlighted formed by the radiation image processing method may be subtracted from the bone portion image or soft tissue portion image representing the given subject to generate a radiation image.

The particular region may be a region of the subject that changed its position between the high energy image and low energy image, and the radiation image of the given subject compensated for image quality degradation with the bone portion of the given subject highlighted formed by the radiation image processing method may be subtracted from the bone portion image or soft tissue portion image representing the given subject to eliminate a motion artifact component produced in the bone portion image or soft tissue portion image.

The training for obtaining the teacher trained filter may be performed with respect to each of a plurality of spatial frequency ranges different from each other, the teacher trained filter may be a filter that forms the radiation image of the given subject with respect to each of the spatial frequency ranges, and each of the radiation images formed with respect to each of the spatial frequency ranges may be combined with each other to obtain a single radiation image.

A second radiation image processing method of the present invention is a method including the steps of:

providing, with respect to each of a plurality of subjects of the same type, an input radiation image constituted by two or more types (e.g., 3 types) of radiation images obtained by radiography of each subject with radiations having different energy distributions;

providing, with respect to each of the subjects, a teacher radiation image, obtained by radiography of each subject, having less image quality degradation than the input radiation image of the subject and representing the subject with a particular region thereof highlighted;

obtaining a teacher trained filter through training using each input radiation image representing each subject as input and the teacher radiation image corresponding to the subject as the teacher so that a radiation image of the subject compensated for image quality degradation with the particular region thereof highlighted is outputted;

obtaining, thereafter, a radiation image of the same type as the input radiation image for a given subject of the same type as the subjects; and

inputting the radiation image of the given subject to the teacher trained filter to form a radiation image of the given subject compensated for image quality degradation with a region thereof corresponding to the particular region highlighted.

A radiation image processing apparatus of the present invention is an apparatus including:

a filter obtaining means for obtaining a teacher trained filter through training using an input radiation image provided with respect to each of a plurality of subjects of the same type, which is constituted by any one of (i) a high energy image and a low energy image obtained by radiography of each of the subjects with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images, and a teacher radiation image provided with respect to each of the subjects, obtained by radiography of each subject, having less image quality degradation than the input radiation image of the subject and representing the subject with a particular region thereof highlighted, wherein each input radiation image representing each subject is used as input, while the teacher radiation image corresponding to the subject is used as the teacher so that a radiation image of the subject compensated for image quality degradation with the particular region thereof highlighted is outputted;

a same type image generation means for generating a radiation image of the same type as the input radiation image for a given subject of the same type as the subjects; and

a region-enhanced image forming means for inputting the radiation image of the given subject to the teacher trained filter to form a radiation image of the given subject compensated for image quality degradation with a region thereof corresponding to the particular region highlighted.

A computer program product of the present invention is a computer readable medium on which is recorded a program for causing a computer to perform a radiation image processing method including the steps of:

obtaining a teacher trained filter through training using an input radiation image provided with respect to each of a plurality of subjects of the same type, which is constituted by any one of (i) a high energy image and a low energy image obtained by radiography of each of the subjects with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images, and a teacher radiation image provided with respect to each of the subjects, obtained by radiography of each subject, having less image quality degradation than the input radiation image of the subject and representing the subject with a particular region thereof highlighted, wherein each input radiation image representing each subject is used as input, while the teacher radiation image corresponding to the subject is used as the teacher so that a radiation image of the subject compensated for image quality degradation with the particular region thereof highlighted is outputted;

generating a radiation image of the same type as the input radiation image for a given subject of the same type as the subjects; and

inputting the radiation image of the given subject to the teacher trained filter to form a radiation image of the given subject compensated for image quality degradation with a region thereof corresponding to the particular region highlighted.

Another radiation image processing method of the present invention is a method including the steps of:

providing, with respect to each of a plurality of subjects of the same type, (a) a region identification image representing a boundary between a particular region and the other region different from the particular region of each subject obtained by radiography of each subject, and (b) a subject image representing each subject, which constitute an input radiation image of each subject;

providing, with respect to each of the subjects, a teacher radiation image representing each subject with the particular region thereof highlighted obtained by radiography of each subject;

obtaining a teacher trained filter through training using each input radiation image representing each subject as input and the teacher radiation image corresponding to the subject as the teacher so that a radiation image of the subject with the particular region thereof highlighted is outputted;

obtaining, thereafter, a radiation image of the same type as the input radiation image for a given subject of the same type as the subjects; and

inputting the radiation image of the given subject to the teacher trained filter to form a radiation image of the given subject with a region thereof corresponding to the particular region highlighted.

Preferably, the radiation dose used in the radiography for generating the teacher radiation image is greater than the radiation dose used in the radiography for generating the subject image.

The teacher radiation image may be a so-called energy subtraction image formed by a weighted subtraction using a high energy image and a low energy image obtained by radiography with radiations having different energy distributions from each other.

The input radiation image may be an image formed by a weighted subtraction using a high energy image and a low energy image obtained by radiography with radiations having different energy distributions from each other, i.e., a so-called an energy subtraction processing. Further, the input radiation image may be a plain radiation image obtained by plain radiography.

The subject image described above may be a plain radiation image obtained by plain radiography.

The particular region may be a region having a particular radiation attenuation coefficient different from the other region.

The subject may be a living tissue and the particular region may be a region including at least one of a bone portion, rib, posterior rib, anterior rib, clavicle, and spine.

The subject may be a living tissue and the other region different from the particular region may be a region including at least one of a lung field, mediastinum, diaphragm, and in-between ribs.

The subject may be a living tissue and the particular region is a bone portion or a soft tissue portion of the living tissue.

The particular region may be a region of the subject that changed its position between the high energy image and low energy image.

The training for obtaining the teacher trained filter may be performed with respect to each of a plurality of spatial frequency ranges different from each other, the teacher trained filter may be a filter that forms the radiation image of the given subject with respect to each of the spatial frequency ranges, and each of the radiation images formed with respect to each of the spatial frequency ranges may be combined with each other to obtain a single radiation image.

Another radiation image processing apparatus of the present invention is an apparatus including:

a filter obtaining means for obtaining a teacher trained filter through training using an input radiation image provided with respect to each of a plurality of subjects of the same type, which is constituted by a region identification image representing a boundary between a particular region and the other region different from the particular region of each subject obtained by radiography of each subject and a subject image representing each subject, and a teacher radiation image, provided with respect to each of the subjects, representing each subject with the particular region thereof highlighted obtained by radiography of each subject, wherein each input radiation image representing each subject is used as input, while the teacher radiation image corresponding to the subject is used as the teacher so that a radiation image of the subject with the particular region thereof highlighted is outputted;

a same type image generation means for generating a radiation image of the same type as the input radiation image for a given subject of the same type as the subjects; and

a region-enhanced image forming means for inputting the radiation image of the given subject to the teacher trained filter to form a radiation image of the given subject with a region thereof corresponding to the particular region highlighted.

Another computer program product of the present invention is a computer readable medium on which is recorded a program for causing a computer to perform a radiation image processing method comprising the steps of:

obtaining a teacher trained filter through training using an input radiation image provided with respect to each of a plurality of subjects of the same type, which is constituted by a region identification image representing a boundary between a particular region and the other region different from the particular region of each subject obtained by radiography of each subject and a subject image representing each subject, and a teacher radiation image, provided with respect to each of the subjects, representing each subject with the particular region thereof highlighted obtained by radiography of each subject, wherein each input radiation image representing each subject is used as input, while the teacher radiation image corresponding to the subject is used as the teacher so that a radiation image of the subject with the particular region thereof highlighted is outputted;

generating a radiation image of the same type as the input radiation image for a given subject of the same type as the subjects; and

inputting the radiation image of the given subject to the teacher trained filter to form a radiation image of the given subject with a region thereof corresponding to the particular region highlighted.

The referent of “subjects of the same type” as used herein means, for example, subjects having substantially the same size, shape, structure with each of the regions thereof having the same radiation attenuation coefficient with each other. For example, for human bodies, the subjects are identical regions with each other, and chests of individual adult males are the subjects of the same type. Further, abdomens of individual adult females or heads of individual children are the subjects of the same type. Still further, for industrial products, subjects having substantially the same size, shape, structure, and material. Further, for example, the subjects of the same type may be portions of individual adult male chests (e.g., ⅓ of the chest on the side of the neck) or the like. Still further, the subjects of the same type may be different small regions of a same subject.

The referent of “generating a radiation image of the same type as the input radiation image for a given subject” as used herein means generating a radiation image of the given subject by performing similar processing to that performed when obtaining the input radiation image. That is, for example, the radiation image of the given subject may be generated by radiography of the given subject under imaging conditions equivalent to those when the input radiation image is obtained, and performing image processing on the radiation image obtained by the radiography, which is similar to that performed when obtaining the input radiation image.

The highlighting of the particular region is not limited to the case in which the particular region is represented more distinguishably than the other region, but also includes the case in which only the particular region is represented.

The referent of “region identification image” as used herein means, for example, an image in which each of the local regions is discriminated into a predetermined tissue, or a boundary between different tissues is discriminated. Further, the region identification image may be obtained by discrimination processing between a particular region and the other region different from the particular region.

According to the first and second radiation image processing methods, apparatuses and computer program produces of the present invention, a teacher trained filter is obtained through training using an input ration image as the target while a teacher radiation image is used as the teacher so that a radiation image of a subject compensated for image quality degradation with a particular region thereof highlighted is outputted. Thereafter, a radiation image of the same type as the input radiation image is generated for a given subject, and the radiation image of the given subject is inputted to the teacher trained filter to form a radiation image of the given subject compensated for image quality degradation with a region of the given subject corresponding to the particular region highlighted. This may improve the quality of a radiation image of a subject without increasing the radiation dose to the subject.

That is, the noise generated when generating a radiation image of the same type as the input radiation image for the given subject may be compensated by inputting the radiation image to the teacher trained filter, since the teacher trained filter may be obtained through training using a teacher radiation image having less noise than the input radiation image as the teacher.

Further, a false image produced in the particular region described above may be suppressed by inputting the radiation image to the teacher trained filter, since an image formed using the high and low energy images described above is used as the input image to be inputted to the teacher trained filter, unlike the conventional method in which only a plain radiation image is inputted to the teacher trained filter, so that the discrimination between the particular region and the other region may be made more clearly.

That is, in the conventional method in which only a plain radiation image is inputted to the teacher trained filter, a false image is produced due to insufficient reliability for estimating a particular region of a subject. In contrast, in the present invention, an image formed using the high and low energy images is inputted to the teacher trained filter so that more image information may be provided for the discrimination between a particular region and the other region of the subject in comparison with the case in which only the plain radiation image is inputted to the teacher trained filter. Accordingly, the reliability for estimating the particular region may be improved by the teacher trained filter, which may also compensate for the false image produced in the radiation image of the given subject described above.

Further, if a greater radiation dose is used for generating the teacher radiation image than that used for generating the input radiation image, the teacher radiation image is secured to have less image quality degradation than the input radiation image, which may improve the quality of the image representing the subject described above.

Still further, if the particular region is a region having a particular radiation attenuation coefficient different from that of the other region, the discrimination between the particular region and the other region of a subject may be made more reliably, which allows a radiation image with the particular region highlighted more accurately to be formed.

According to another radiation image processing method, apparatus, and computer program product of the present invention, a teacher trained filter is obtained through training using an input ration image as the target while a teacher radiation image is used as the teacher so that a radiation image of a subject with a particular region thereof highlighted is outputted. Thereafter, a radiation image of the same type as the input radiation image is generated for a given subject, and the radiation image of the given subject is inputted to the teacher trained filter to form a radiation image of the given subject with a region of the given subject corresponding to the particular region highlighted. This may improve the quality of a radiation image of a subject without increasing the radiation dose to the subject.

That is, unlike the conventional method in which only a plain radiation image is inputted to the teacher trained filter, a region identification image representing a boundary between a particular region and the other region of a subject and a subject image representing the subject are used as the input image to be inputted to the teacher trained filter, so that the generation of the false image described above may also be suppressed.

More specifically, in the conventional method in which only a plain radiation image is inputted to the teacher trained filter, a false image is produced due to insufficient reliability for estimating a particular region of a subject. In contrast, in the present invention, a region identification image representing the boundary described above is inputted to the teacher trained filter in addition to a subject image representing the subject, so that more image information may be provided for the discrimination between a particular region and the other region of the subject in comparison with the case in which only the plain radiation image is inputted to the teacher trained filter. Accordingly, the reliability for estimating the particular region may be improved by the teacher trained filter, which may compensate for the false image produced in the radiation image of the given subject described above.

In this way, a radiation image of a given subject with a particular region thereof highlighted may be generated without increasing the radiation dose to the given subject and the quality of the radiation image representing the given subject may be improved.

Further, the use of an image, as the teacher radiation image, having less image quality degradation, caused by noise and the like, than the subject image and region identification image constituting the training radiation image corresponding to the teacher radiation image allows the teacher trained filter to be trained so as to compensate for image quality degradation. Then, by inputting a radiation image of the same type as the input radiation image to the teacher trained filter, a radiation image compensated for the image quality degradation occurred in the radiation image of the same type as the input radiation image when it is generated may be obtained.

Still further, if a greater radiation dose is used for generating the teacher radiation image than that used for generating the subject image, the teacher radiation image is secured to have less image quality degradation than the subject image constituting the input radiation image, which may improve the quality of the image representing the subject described above.

Further, if an energy subtraction image formed by a weighted subtraction using a high energy image and a low energy image obtained by radiography with radiations having different energy distributions from each other, i.e., a so-called an energy subtraction processing is used as the teacher radiation image, it may become more reliably an image with the particular region highlighted.

Here, if the particular region is a region having a particular radiation attenuation coefficient different from that of the other region, the boundary between the particular region and the other region of a subject may be determined more reliably, which allows a radiation image with the particular region highlighted more accurately to be formed.

### BRIEF DESCRIPTION OF THE DRAWINGS

FIG. 1 illustrates a procedure for obtaining a teacher trained filter used for the radiation image processing method according to a first embodiment of the present invention.

FIG. 2 illustrates a procedure of the radiation image processing method of the first embodiment.

FIG. 3 illustrates a procedure for obtaining a teacher trained filter used for the radiation image processing method according to a second embodiment of the present invention.

FIG. 4 illustrates a procedure of the radiation image processing method of the second embodiment.

FIG. 5 illustrates how to obtain an image formed of a plurality of spatial frequency ranges from teacher radiation images.

FIG. 6 illustrates how to obtain, through training, a teacher trained filter with respect to each spatial frequency range.

FIG. 7 illustrates how to obtain a diagnostic radiation image by inputting an input radiation image to the teacher trained filter with respect to each spatial frequency range.

FIG. 8 illustrates regions forming a characteristic amount.

FIG. 9 illustrates how to obtain an approximate function based on support vector regression.

FIG. 10 illustrates a procedure for obtaining a teacher trained filter used for the radiation image processing method according to a third embodiment of the present invention.

FIG. 11 illustrates a procedure of the radiation image processing method of the third embodiment.

FIG. 12 illustrates a motion artifact produced in a bone portion image representing a chest.

FIG. 13 illustrates up-sampling and addition in an image composition filter.

FIG. 14 illustrates a procedure for obtaining a teacher trained filter used for the radiation image processing method according to a fourth embodiment of the present invention.

FIG. 15 illustrates a procedure of the radiation image processing method of the fourth embodiment.

FIG. 16 illustrates a procedure for obtaining a teacher trained filter used for the radiation image processing method according to a fifth embodiment of the present invention.

FIG. 17 illustrates a procedure of the radiation image processing method of the fifth embodiment.

FIG. 18 illustrates a boundary extraction process.

FIG. 19 illustrates two class discrimination based on a support vector machine.

FIG. 20 illustrates how to set a sub-window in a radiation image to be discriminated and a teacher image.

FIG. 21 illustrates how to generate a diagnostic radiation image for a given subject by inputting radiation images of respective spatial frequency ranges to a teacher trained filter.

FIG. 22 illustrates how to obtain a teacher trained filter with respect to each spatial frequency range.

FIG. 23 illustrates a multi-resolution conversion of an image.

FIG. 24 illustrates up-sampling and addition in an image composition filter.

FIG. 25 illustrates regions forming a characteristic amount.

FIG. 26 illustrates how to obtain an approximate function based on support vector regression.

FIG. 27 illustrates a motion artifact produced in a bone portion image representing a chest.

### BEST MODE FOR CARRYING OUT THE INVENTION

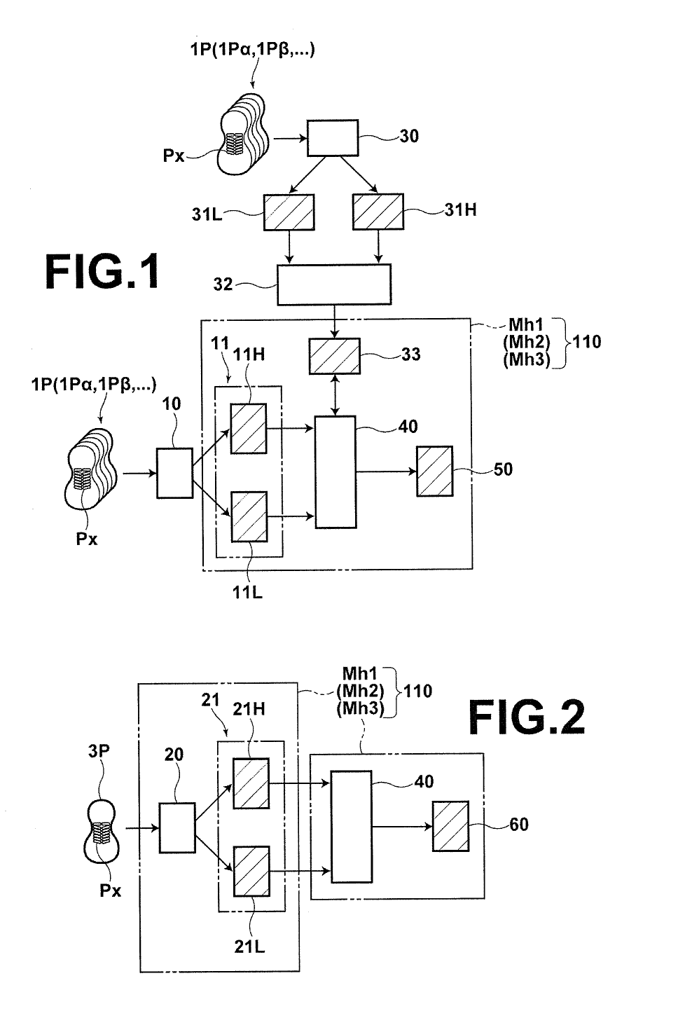

Hereinafter, the radiation image processing method, apparatus, and computer program product according to the present invention will be described. The radiation image processing method according to a first embodiment of the present invention uses a high energy image and a low energy image obtained by radiography with radiations having different energy distributions from each other as the input radiation image. FIG. 1 illustrates a procedure for obtaining a teacher trained filter used for the radiation image processing method according to the first embodiment of the present invention. FIG. 2 illustrates a procedure of the radiation image processing method that obtains a diagnostic target image using the teacher trained filter described above. Each of the hatched portions in the drawings indicates an image or image data representing the image.

According to the radiation image processing method of the first embodiment, an input radiation image 11 constituted by a high energy image 11H and a low energy image 11L is provided first, which are obtained by radiography 10 of each of a plurality of subjects 1Pα, 1Pβ, - - - (hereinafter, also collectively referred to as the “subjects 1P”) of the same type with radiations having different energy distributions from each other, as illustrated in FIG. 1. Also, with respect to each of the subjects 1P, a teacher radiation image 33 having less image quality degradation than either of the high energy image 11H and low energy image 11H constituting the input radiation image 11, and representing each of the subjects 1P with a particular region Px being enhanced is provided, which is obtained by radiography 30 of each of the subjects 1P. Then, a teacher trained filter 40 trained with the input radiation image 11 as the target and the teacher radiation image 33 as the teacher with respect to each of the subjects 1P is obtained.

That is, the teacher trained filter 40 is obtained by training the filter using the provided input radiation images 11 and teacher radiation images 33 such that when each of the input radiation images 11 generated for each of the subjects 1Pα, 1Pβ, - - - is inputted, a radiation image 50 representing the radiation image of each of the subjects 1P compensated for image quality degradation occurred in the input radiation image 11 with the particular region Px thereof highlighted is outputted with the teacher radiation image 33 corresponding to each of the subjects 1P as the model.

More specifically, the teacher trained filter 40 is obtained by training the filter such that, for example, when the input radiation image 11 generated for the subject 1Pα is inputted, a radiation image 50 representing the radiation image of the subject 1Pα compensated for image quality degradation occurred in the input radiation image 11 with the particular region Px thereof highlighted is outputted using the teacher radiation image 33 representing the subject 1Pα as the model.

Note that the teacher trained filter 40 may be obtained by training the filter using a pair of the input radiation image 11 and teacher radiation image 33 corresponding to, for example, each of several different types of subjects (e.g., three different types of subjects 1Pα, 1Pβ, 1Pγ).

Here, the subject is assumed to be a living tissue, and the particular region Px of the subject is assumed to be the bone portion. Further, the radiography using radiations having different energy distributions from each other described above may be the dual shot radiography or single shot radiography.

Each of the teacher radiation images 33 is an energy subtraction image representing the bone portion obtained by weighted subtraction 32, i.e., an energy subtraction of a high energy image 31H and a low energy image 31L obtained by radiography 30 of each of the subjects 1P using higher radiation doses than the radiation doses used by the radiography 10 of each of the subjects 1P for generating each of the input radiation images 11.

Here, the sum of the individual radiation doses to each of the subjects 1P used by the radiography 30 when generating each of the teacher radiation images 33 is greater than the sum of the individual radiation doses to each of the subject 1P used by the radiography 10 when generating each of the input radiation images 11.

After obtaining the teacher trained filter 40, radiography 20 is performed for a given single diagnostic target subject 3P of the same type as the subject 1P to generate a radiation image 21 of the same type as the input radiation image 11, as illustrated in FIG. 2. Then, a diagnostic radiation image 60 compensated for image quality degradation occurred in the radiation image of the subject 3P with the particular region Px thereof highlighted is formed by inputting the radiation image 21 to the teacher trained filter 40 obtained in the manner as described above.

The radiation image of the same type as the input radiation image 11 is constituted by a high energy image 21H and a low energy image 21L obtained by the radiography 20 of the given subject 3P using radiations having different energy distributions from each other, i.e., the radiography under substantially the same imaging conditions as the radiography 10. That is, the input radiation image 11 and the radiation image 21 are obtained by radiography in which radiations having substantially the same energy distribution with substantially the same radiation dose are irradiated to the subject.

Each of the subjects 1Pα, 1Pβ, - - - used for generating the input radiation images 11 and teacher radiation images, and subject 3P given when generating the diagnostic target image 60 are of the same type. That is, the subjects 1Pα, 1Pβ, - - - , and 3P are subjects having substantially the same shape, structure, and size with each of the regions thereof having the same radiation attenuation coefficient, and the like. For example, the subjects 1Pα, 1Pβ, - - - , and 3P of the same type may be adult male chests.

As described above, according to the radiation image processing method of the first embodiment, the quality of a radiation image representing a diagnostic target subject may be improved without increasing the radiation dose to the subject.

Next, the radiation image processing method according to a second embodiment will be described with reference to the accompanying drawings. The second embodiment uses an energy subtraction image formed by a weighted subtraction using a high energy image and a low energy image obtained by radiography with radiations having different energy distributions from each other and the high energy image as an input radiation image.

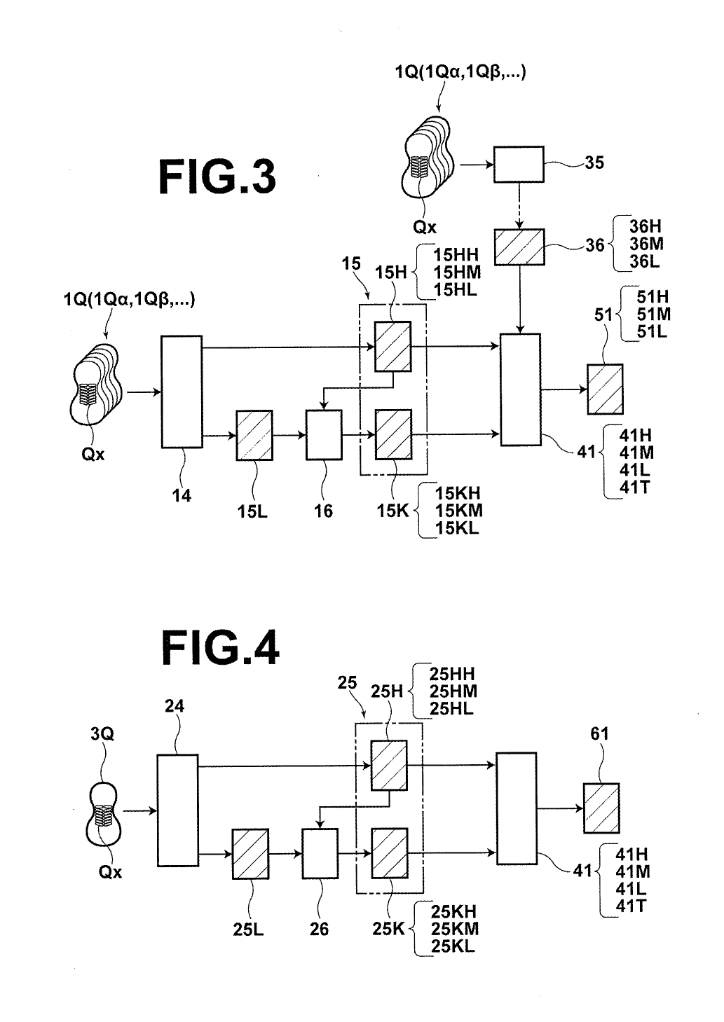

FIG. 3 illustrates a procedure for obtaining a teacher trained filter used for the radiation image processing method according to the second embodiment, and FIG. 4 illustrates a procedure of the radiation image processing method using the teacher trained filter described above.

According to the radiation image processing method of the second embodiment, an input radiation image 15 is provided first, which is formed based on radiography 14 of each of a plurality of adult female chest subjects of the same type 1Qα, 1Qβ, . . . (hereinafter, also collectively referred to as the “chests 1Q”) with radiations having different energy distributions from each other, as illustrated in FIG. 3.

That is, for each of the subject chests 1Q, the input radiation image 15 constituted by a bone portion image 15K with much noise corresponding to one type of energy subtraction image formed by a weighted subtraction 16 using a high energy image 15H with less noise obtained by the radiography 14 with a high radiation dose and a low energy image 15L with much noise obtained by the radiography 14 with a low radiation dose, and the high energy image 15H are provided. The high radiation dose radiography is radiography that irradiates a high radiation dose to the subject, and the low radiation dose radiography is radiography that irradiates a low radiation dose than the high radiation dose to the subject.

The bone portion image 15K is an image that mainly represents a particular region of each of the chests 1Q, i.e., a bone portion Qx which is a region of each of the chests 1Q showing a particular radiation attenuation coefficient.

Further, with respect to each of the chest subjects 1Qα, 1Qβ, - - - , a teacher radiation image 36 having less image quality degradation than the high energy image 15H and the bone portion image 15K, and mainly representing the bone portion Qx that shows a particular radiation attenuation coefficient is provided, which is obtained by radiography 35 of each of the subject chests 1Qα, 1Qβ, - - - .

Each of the teacher subject images 36 representing the bone portion Qx may be formed, for example, by a weighted subtraction using a high energy image and a low energy image obtained by radiography 35 of each of the chests 1Qα, 1Qβ, - - - with radiation doses greater than those used for the respective radiography with respect to each of the chests 1Qα, 1Qβ, - - - when each of the input radiation images 15 is generated.

Next, a teacher trained filter 41 trained with the input radiation image 15 constituted by the bone portion image 15K and high energy image 15H as the target and the teacher radiation image 36 as the teacher is obtained.

That is, the teacher trained filter 41 is obtained by training the filter using each of the teacher radiation images 36 as the teacher such that when the bone portion image 15K and high energy image 15H constituting the input radiation image 15 for each of the chests 1Qα, 1Qβ, - - - is inputted, a radiation image 51 compensated for image quality degradation and mainly representing the bone portion Qx of each of the chests 1Qα, 1Qβ, - - - is outputted.

Here, the teacher trained filter 41 is obtained by training the filter such that, for example, when the input radiation image 15 of the chest 1Qα is inputted, a radiation image 51 of the chest 1Qα compensated for image quality degradation and mainly representing the bone portion Qx, which is a particular region of the chest 1Qα, is outputted using the teacher radiation image 36 representing the chest 1Qα as the teacher.

After the teacher trained filter 41 is obtained, for a diagnostic target adult female chest 3Q which is the same type as the chest 1Q, a radiation image 25 which is the same type as the input radiation image 15 is generated, which is then inputted to the teacher trained filter 41 to output a diagnostic radiation image 61 compensated for image quality degradation and mainly representing the bone portion Qx which is a particular region of the diagnostic target chest 3Q.

The radiation image 25 is constituted by a bone portion image 25K with much noise, which is an energy subtraction image formed by a weighted subtraction operation 26 using a high energy image 25H with less noise obtained by the radiography 24 with a high radiation dose and a low energy image 25L with much noise obtained by the radiography 24 with a low radiation dose, and the high energy image 25H.

Note that a soft tissue portion image having less noise, which is a second diagnostic radiation image, may be generated by subtracting the diagnostic radiation image 61 having less noise and mainly representing the bone portion from the high energy image 25H.

As described above, according to the second embodiment of the present invention, the quality of a radiation image representing the subject described above may be improved without increasing the radiation dose to the subject.

Now, the teacher trained filter 41 will be described in detail. As for the method for transforming a single image into a plurality of images of different spatial frequency ranges from each other, then generating a plurality of processed images of different spatial frequency ranges from each other by performing image processing on each of the transformed images, and obtaining a single processed image by combining the plurality of processed images as will be described hereinbelow, any of various known methods may be used.

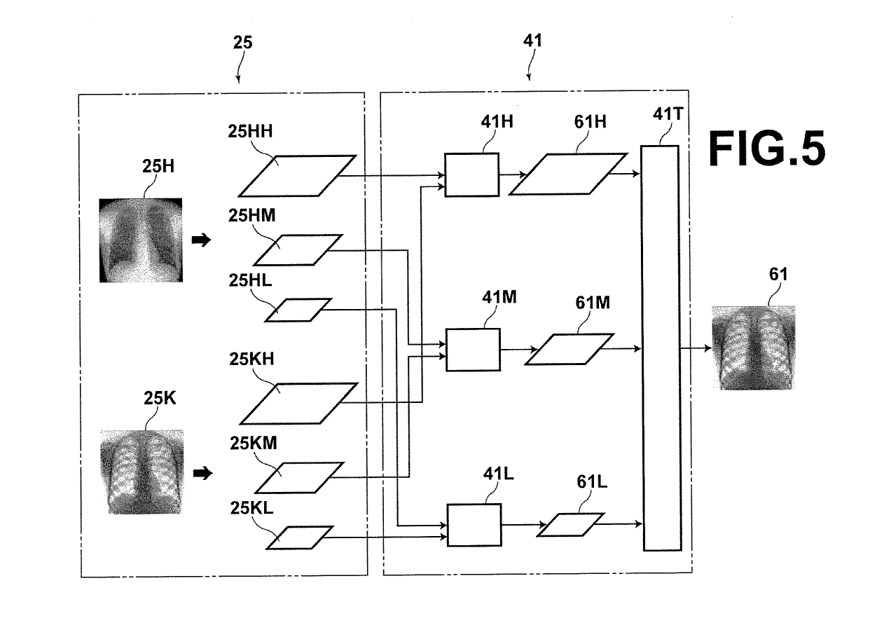

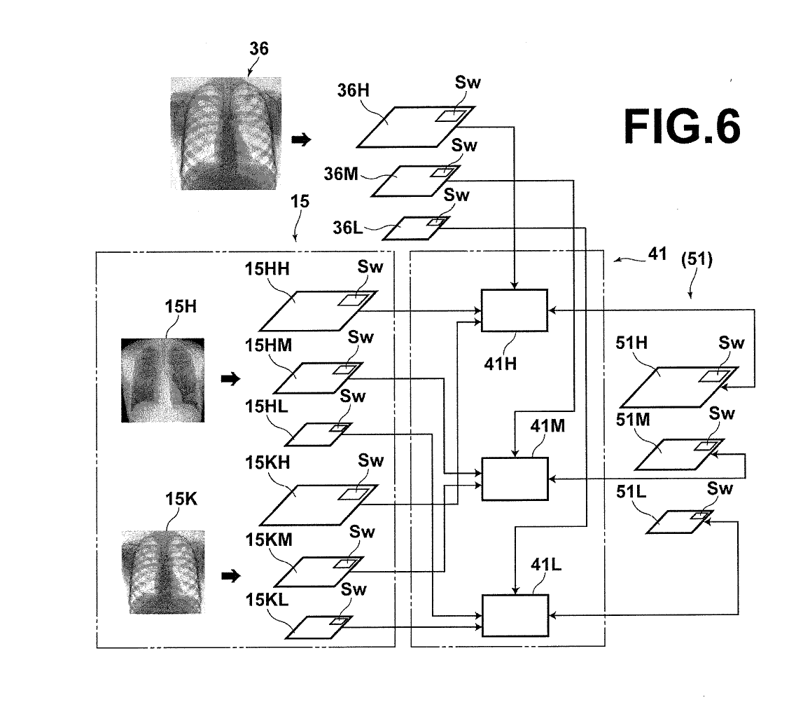

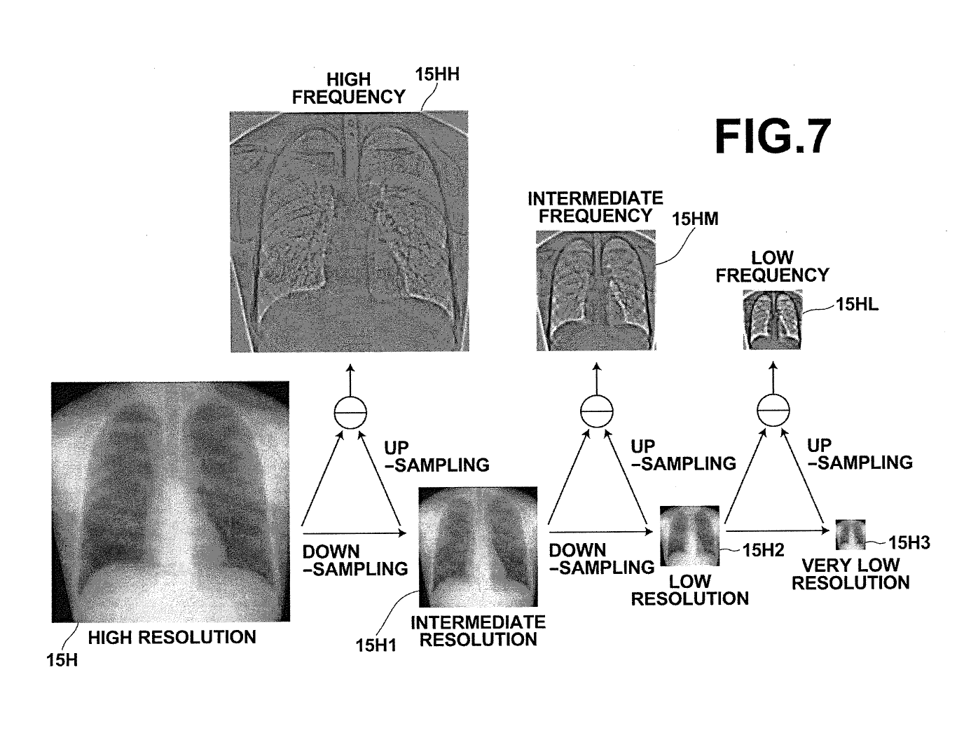

FIG. 5 illustrates how to obtain a diagnostic radiation image by inputting an input radiation image to a teacher trained filter with respect to each spatial frequency range. FIG. 6 illustrates how to obtain, through training, a teacher trained a filter with respect to each spatial frequency range, and FIG. 7 illustrates how to obtain a teacher radiation image formed of a plurality of spatial frequency ranges. FIG. 13 illustrates up-sampling and addition in an image composition filter.

Here, the input radiation image of each of a plurality of subjects of the same type is assumed to be an image selected from a group of radiation images consisting of a high energy image and a low energy image obtained by radiography with radiations having different energy distributions from each other, and one or more types of energy subtraction images formed by weighted subtractions using the high and low energy images. Here, the input radiation images are assumed to be a plurality of bone portion images which are a plurality of high energy images of different spatial frequency ranges from each other and a plurality of energy subtraction images of the different spatial frequency ranges from each other. The teacher radiation images are assumed to be a plurality of teacher radiation images of the different spatial frequency ranges from each other obtained by radiography of subjects of the same type as the subjects described above, which have less image quality degradation than the input radiation images and represent the subjects with a particular region thereof highlighted.

The teacher trained filter is assumed to be a filter trained with the input radiation images, each constituted by each of a plurality of high energy images of the different spatial frequency ranges from each other and each of a plurality of bone portion images of the different spatial frequency ranges from each other, as the target and a plurality of teacher images of the different spatial frequency ranges from each other as the teacher.

Then, for a given subject of the same type as the subject described above, a plurality of radiation images of the different spatial frequency ranges from each other of the same type as the input radiation images described above is generated, then the plurality of radiation images of the different spatial frequency ranges from each other is inputted to the teacher trained filter to form a plurality of radiation images of the different spatial frequency ranges from each other compensated for image quality degradation with the particular region of the subject highlighted. Then, the plurality of radiation images is combined to generate a single radiation image.

That is, the teacher trained filter 41 is a filter that generates a plurality of diagnostic target radiation images of the respective spatial frequency ranges 61H, 61M, 61L based on input of radiation images of different spatial frequency ranges from each other obtained by performing multi-resolution conversions on a high energy image 25H and a bone portion image 25K of a given diagnostic target subject 3Q, and obtains a diagnostic radiation image 61 by combining the plurality of generated radiation images 61H, 61M, 61L, as illustrated in FIG. 5.

Here, the teacher trained filter 41 includes a high frequency range teacher trained filter 41H, an intermediate frequency range teacher trained filter 41M, a low frequency range teacher trained filter 41L, an image composition filter 41T, and the like.

As illustrated in FIG. 6, the teacher radiation images 36H, 36M, 36L of each of the spatial frequency ranges representing the chest portion 1Q provided for generating the teacher trained filter 41 are images compensated for image quality degradation and mainly representing the bone portion, which is the particular region described above, obtained by performing a multi-resolution conversion on a radiation image 36 (bone portion high resolution image).

Further, each of the bone portion images 15KH, 15KM, 15KL of the respective spatial frequency ranges, and each of the high energy images 15HH, 15HM, 15HL representing the chest portion 1Q provided for generating the teacher trained filter 41 are obtained by performing a multi-resolution conversion on each of the bone portion image 15K and high energy image 15H as in the teacher radiation image 36.

More specifically, as the teacher images, the following images of the respective spatial frequency ranges obtained by performing a multi-resolution conversion on the teacher radiation image 36 are provided. Namely, a radiation image representing a high frequency range (teacher high frequency range image 36H), a radiation image representing an intermediate frequency range (teacher intermediate frequency range image 36M), and a radiation image representing a low frequency range (teacher low frequency range image 36L) are provided.

Further, as the bone portion images, the following images of the respective spatial frequency ranges obtained by performing a multi-resolution conversion on the bone portion image 15K are provided. Namely, a radiation image representing a high frequency range (bone portion high frequency range image 15KH), a radiation image representing an intermediate frequency range (bone portion intermediate frequency range image 15KM), and a radiation image representing a low frequency range (bone portion low frequency range image 15KL) are provided.

As the high energy images, the following images of the respective spatial frequency ranges obtained by performing a multi-resolution conversion on the high energy image 15H are provided. Namely, a radiation image representing a high frequency range (high energy high frequency range image 15HH), a radiation image representing an intermediate frequency range (high energy intermediate frequency range image 15HM), and a radiation image representing a low frequency range (high energy low frequency range image 15HL) are provided.

For example, the high energy high frequency range image 15HH is obtained by up-sampling the high energy image 15H (high energy high resolution image), which is the high energy high resolution image described above, and a high energy intermediate resolution image 15H1 obtained by down-sampling the high energy image 15H, as illustrated in FIG. 7.

In the down-sampling described above, Gaussian lowpass filtering with σ=1, and ½ skipping of the high energy image 15H are performed. The up-sampling is performed through a cubic B-spline interpolation.

The high energy intermediate frequency range image 15HM is obtained by up-sampling the high energy intermediate resolution image 15H1 and a high energy low resolution image 15H2 obtained by down-sampling the high energy intermediate resolution image 15H1 as in the case of the high energy high frequency range image 15HH.

The high energy low frequency range image 15HL is obtained by up-sampling the high energy low resolution image 15H2 and a high energy very low resolution image 15H3 obtained by down-sampling the high energy low resolution image 15H2, as in the case of the high energy high frequency range image 15HH or high energy intermediate frequency range image 15HM.

Then, the teacher trained filter 41 is obtained for each of the three spatial frequency ranges described above. That is, the high frequency range teacher trained filter 41H, intermediate frequency range teacher trained filter 41M, and low frequency range teacher trained filter 41L are obtained through training with respect to each of the spatial frequency ranges.

Hereinafter, with reference to FIG. 6, a description will be made of a case in which the high frequency range teacher trained filter 41H is obtained through training.

As illustrated in FIG. 6, a sub-window Sw is set to each of the bone portion high frequency range image 15KH, high energy high frequency range image 15HH, and teacher high frequency range image 36H, which is a small rectangular area of 5×5 pixels (25 pixels in total) corresponding to each other.

Then, with respect to a characteristic amount constituted by 25 pixel values forming the sub-window Sw of each of the bone portion high frequency range image 15KH and high energy high frequency range image 15HH, a training sample, with the value of the center pixel of the sub-window Sw of the teacher high frequency range image 36H as the target value, is extracted. In this way, while moving the sub-windows, a plurality of training samples is extracted. The high frequency range teacher trained filter 41H is obtained through training using the extracted samples of, for example, 10,000 types.

The high frequency range image 51H, intermediate frequency range image 51M and low frequency range image 51L to be described later are images similar to the teacher high frequency range image 36H, teacher intermediate frequency range image 36M, and teacher intermediate frequency range image 36L respectively.

The high frequency range teacher trained filter 41H is a filter that has learned a regression model using support vector regression to be described later. The regression model is a non-linear high frequency range filter that outputs a high frequency range image 51H compensated for image quality degradation and mainly representing the bone portion, which is the particular region described above, according to inputted characteristic amount (image represented by the 25 pixels described above) of the bone portion high frequency range image 15KH and inputted characteristic amount (image represented by the 25 pixels described above) of the high energy high frequency range image 15HH.

The intermediate frequency range teacher trained filter 41M is obtained through training, which is similar to that described above, using the bone portion intermediate frequency range image 15KM, high energy intermediate frequency range image 15HM, and teach intermediate frequency range image 36M.

Further, the low frequency range teacher trained filter 41L is obtained through training, which is similar to that described above, using the bone portion low frequency range image 15KL, high energy low frequency range image 15HL, and teach low frequency range image 36L.

As described above, the training of the regression model is performed with respect to each of the spatial frequency ranges, thereby the teacher trained filter 41, constituted by the teacher trained filter 41H, teacher trained filter 41M, and teacher trained filter 41L, are obtained.

As illustrated in FIG. 5, an image with respect to each of the frequency ranges obtained by performing a multi-resolution conversion on each of the bone portion image 25K and high energy image 25H, constituting the diagnostic target image 25 generated for the given diagnostic target adult female chest 3Q of the same type as the input radiation image 15 is inputted to the teacher trained filter 41 obtained in the manner as described above.

That is, the bone portion high frequency range image 25KH, bone portion intermediate frequency range image 25KM, and bone portion low frequency range image 25KL obtained by performing a multi-resolution conversion on the bone portion image 25K, and the high energy high frequency range image 25HH, high energy intermediate frequency range image 25HM, and high energy low frequency range image 25HL obtained by performing a multi-resolution conversion on the high energy image 25H are inputted to the teacher trained filter 41.

Then, the teacher trained filters 41H, 41M, 41L, to which images of the respective spatial frequency ranges obtained by performing multi-resolution conversions on the bone portion image 25K and high energy image 25H are inputted, estimate diagnostic target images 61H, 61M, 61L of the respective spatial frequency ranges, and combine the estimated the diagnostic target images 61H, 61M, 61L together through the image composition filter 41T, thereby obtaining the diagnostic radiation image 61.

That is, when the bone portion high frequency range image 25KH and high energy high frequency range image 25HH are inputted to the high frequency range teacher trained filter 41H, the high frequency range diagnostic target radiation image 61H compensated for image quality degradation is formed.

When the bone portion intermediate frequency range image 25KM and high energy intermediate frequency range image 25HM are inputted to the intermediate frequency range teacher trained filter 41M, the intermediate frequency range diagnostic target radiation image 61M compensated for image quality degradation is formed.

Further, when the bone portion low frequency range image 25KL and high energy low frequency range image 25HL are inputted to the low frequency range teacher trained filter 41L, the low frequency range diagnostic target radiation image 61L compensated for image quality degradation is formed.

Then, the high frequency range diagnostic target radiation image 61H, intermediate frequency range diagnostic target radiation image 61M, and low frequency range diagnostic target radiation image 61L formed in the manner as described above are combined together by the image composition filter 41T, thereby the diagnostic radiation image 61 is generated.

The image composition filter 41T obtains the diagnostic radiation image 61 by repeating up-sampling and addition in the order of low frequency range diagnostic target radiation image 61L intermediate frequency range diagnostic target radiation image 61M, and high frequency range diagnostic target radiation image 61H, as illustrated in FIG. 13.

That is, an image is obtained by adding an image obtained by up-sampling the low frequency range diagnostic target radiation image 61L to the intermediate frequency range diagnostic target radiation image 61M, and the diagnostic target radiation image 61 is obtained by adding an image obtained by up-sampling the obtained image to the high frequency diagnostic target image 61H.

As described above, the teacher trained filter is obtained through training with respect to each of a plurality of spatial frequency ranges.

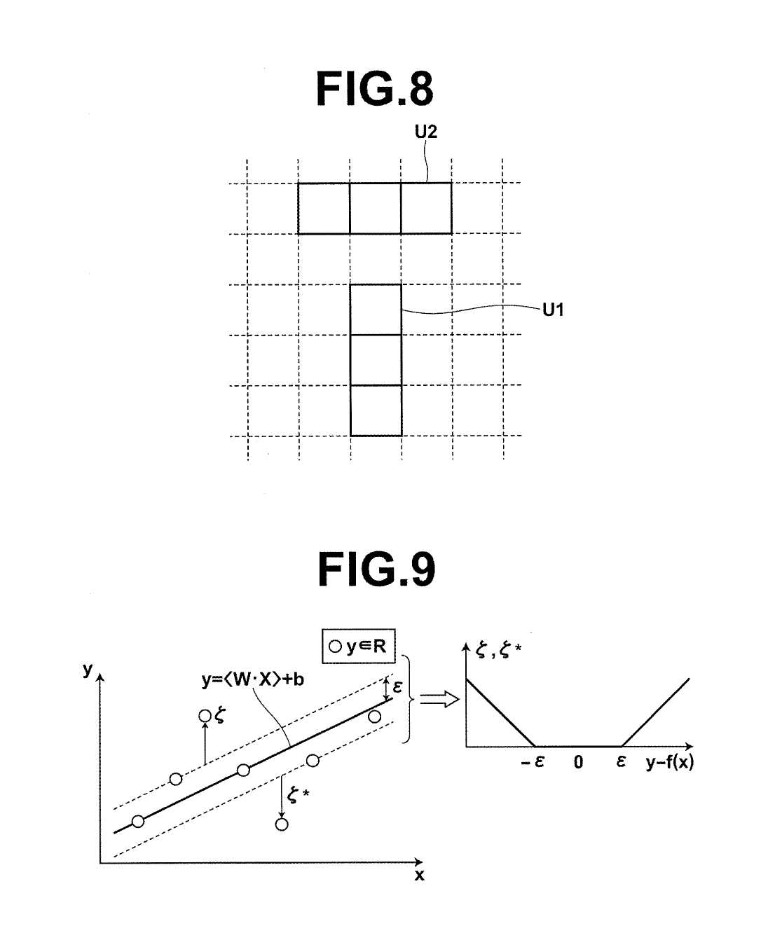

The input characteristic amount in the regression model training will now be described in detail. FIG. 8 illustrates example regions forming the characteristic amount.

The characteristic amount may not necessarily be a pixel value itself in the radiation images of the respective spatial frequency ranges, but may be that obtained by performing particular filtering thereon. For example, as illustrated in FIG. 8, the average pixel value in the region U1 or U2 including three adjacent pixels in the vertical or horizontal direction of an image of a particular spatial frequency range may be used as a new characteristic amount. Further, a wavelet conversion may be performed and the wavelet coefficient may be used as the characteristic amount. Still further, a pixel across a plurality of frequency ranges may be used as the characteristic amount.

Next, contrast normalization performed in the regression model training will be described.

A standard deviation is calculated for the pixel value of each of the pixels included in the sub-window Sw (FIG. 6) of each frequency range image. The pixel values of the frequency range image are multiplied by a coefficient so that the standard deviation corresponds to a predetermined target value.

I′=I×(C/SD)

where, I is the pixel value of the original image, I′ is the pixel value after contrast normalization, SD is the standard deviation of the pixels within the sub-window Sw, and C is the target value (predetermined constant) of the standard deviation.

The sub-window Sw is scanned over the entire region of each of the radiation images, and for all of the sub-windows that can be set on each image, the normalization is performed by multiplying the pixel values within the sub-windows by a predetermined coefficient such that the standard deviation is brought close to the target value.

As a result of the normalization, the magnitude of the amplitude (contrast) of each spatial frequency range image is aligned. This reduces image pattern variations in the radiation images of the respective spatial frequency ranges inputted to the teacher trained filter 41, which provides the advantageous effect of improving the estimation accuracy for the bone portion.

In the step of training the teacher trained filter, which is a non-linear filter, the contrast normalization is performed on the high energy image, and the coefficient used is also used for multiplying the bone portion image without image quality degradation. Training samples are provided from pairs of normalized high energy images and bone portion images to train the non-linear filter.

In the step of estimating the diagnostic target radiation image mainly representing the bone portion of a diagnostic target subject, the contrast normalization is performed on the high energy image to be inputted, and pixel values of normalized images of the respective spatial frequency ranges are inputted to the teacher trained filter. The output value of the teacher trained filter is multiplied by the inverse of the coefficient used in the normalization, and the result is used as the estimated value of the bone portion.

Next, support vector regression (regression by support vector machine (SVR)) will be described. FIG. 9 illustrates how to obtain an approximate function by support vector regression. For a problem of training a function for approximating a real value y which corresponds to d-dimensional input vector x, first considering a case in which the approximate function is linear.

f(x)= [symbol] w·x [symbol] +b w,xεR^{d},bεR (1)

In the ε-SVR algorithm proposed by Vapnik, a value of “f” for minimizing the following loss function is obtained.

For details of the ε-SVR algorithm proposed by Vapnik, refer to “An Introduction to Support Vector Machines and other kernel-based learning methods”, by Nello Cristianini and John Shawe-Taylor, Cambridge University Press 2000, UK, pp. 110-119.

$$Minimization \frac{1}{2} 〈 w \cdot w 〉 + C \cdot {R}_{emp} [ f ] \qquad ( 2 )$$

The <w·w> is the term representing complexity of the model for approximating data, and Rₑₘₚ[f] may be expressed like the following.

$${R}_{emp} [ f ] = \frac{1}{l} {\sum }_{i = 1}^{l} {\vert {y}_{i} - f ( {x}_{i} ) \vert}_{ɛ} = \frac{1}{l} {{\sum }_{i = 1}}^{l} ( {ξ}_{i} + {ξ}_{i}^{*} ) \qquad ( 3 )$$

where, |y−f(x)|ε=max{0, |y−f(x)|−ε}, indicating that an error smaller than ε is disregarded. ξ and ξ* are the moderators that allow errors exceeding ε in the positive and negative directions respectively. C is the parameter for setting a tradeoff between the complexity of the model and moderation of the constraint.

The main problem described above is equivalent to solving the following dual problem, and from the nature of the convex quadratic program problem, a global solution may be invariably obtained.

$$Maximization {\sum }_{i = 1}^{l} {y}_{i} {α}_{i} - ɛ {\sum }_{i = 1}^{l} \vert {α}_{i} \vert - \frac{1}{2} {\sum }_{i , j = 1}^{l} {α}_{i} {α}_{j} 〈 {x}_{i} \cdot {x}_{j} 〉 \\ Condition {\sum }_{i = 1}^{l} {α}_{i} = 0 , - C \leq {α}_{i} \leq C , i = 1 , … , l . \qquad ( 4 )$$

The regression model obtained by solving the problem is expressed like the following.

$$f ( x ) = {\sum }_{i = 1}^{l} {α}_{i} 〈 {x}_{i} \cdot x 〉 + b \qquad ( 5 )$$

This function is a linear function. In order to extend it to a nonlinear function, it is only necessary to project the input x onto a higher order characteristic space Φ(x) and to regard the vector Φ(x) in the characteristic space as the input x(x→Φ(x)). In general, the projection onto a higher order space accompanies largely increased amount of calculations. But, replacement of an inner product term appearing in the formula to be optimized with a kernel function that satisfies the relationship of K(x, y)=<Φ(x), Φ(y)> may provides, with the input order calculations, the same calculation result as that obtained after projecting to a higher order space. As for the kernel function, RBF kernel function, polynomial kernel, or sigmoid kernel may be used.

Next, the radiation image processing method according to a third embodiment will be described with reference to the accompanying drawings. The third embodiment uses, as the input radiation image, only an energy subtraction image formed by a weighted subtraction using a high energy image and a low energy image obtained by radiography with radiations having different energy distributions from each other.

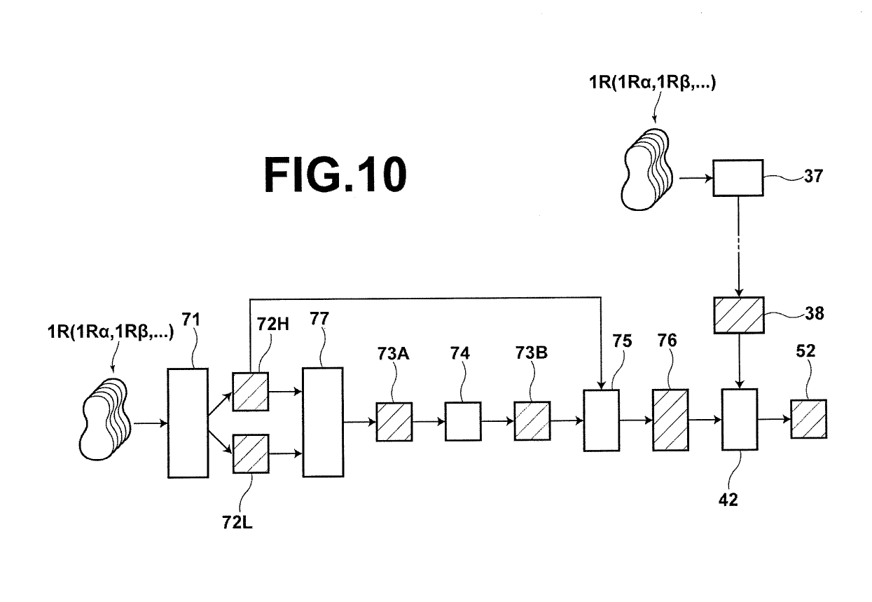

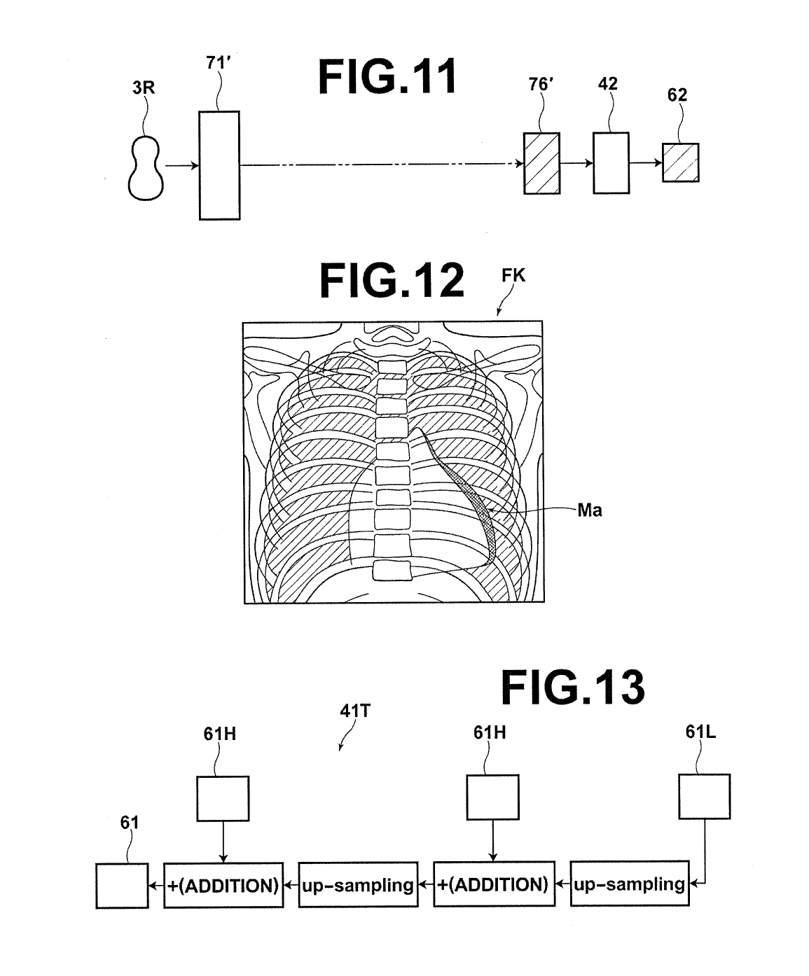

FIG. 10 illustrates a procedure for obtaining a teacher trained filter used for the radiation image processing method according to the third embodiment, and FIG. 11 illustrates a procedure of the radiation image processing method using the teacher trained filter described above.

According to the radiation image processing method of the third embodiment, a high energy image 72H and a low energy image 72L are obtained first by radiography 71 of each of adult female chest subjects of the same type 1Rα, 1Rβ, - - - (hereinafter, also collectively referred to as the “chests 1R”) with radiations having different energy distributions from each other. Then, a soft tissue portion image 73A with much noise is formed, which is one type of energy subtraction image formed by a weighted subtraction operation 77 using the high energy image 72H with less noise obtained by the radiography with a high radiation dose and the low energy image 72L with much noise obtained by the radiography with a low radiation dose. Thereafter, lowpass filtering 74 is performed on the soft tissue portion image 73A to obtain a soft tissue portion image 73B removed of a high frequency component. Further, an input radiation image 76, which is a bone portion image with less noise as a whole from the high frequency side to the low frequency side, although including more soft components as the frequency increases, is provided by a subtraction operation 75 for subtracting the soft tissue portion image 73B, removed of the high frequency component, from the high energy image 72H with less noise.

The referent of “high frequency component” as used herein means a high spatial frequency component in an image, and “low frequency component” means a low spatial frequency component.

Here, the soft tissue portion image 73A has much noise components on the high frequency side than the low frequency side, but the noise components are removed by the lowpass filtering 74. Thus, the input radiation image 76, which is the bone portion image described above, has less noise as a whole.

Further, teacher radiation images 38 are provided through radiography 37 of the adult female chest subjects 1Rα, 1Rβ, - - - , which are bone images representing a particular region of the target subjects of the radiography 37, i.e., the chests 1R having less image quality degradation.

Then, a teacher trained filter 42 trained with the input radiation images 76 as the target and the teacher radiation images 38 as the teacher is obtained.

That is, the teacher trained filter 42 is obtained by training the filter using the input radiation image 76 and teacher radiation image 38 as a pair provided for each of the chest subjects 1R, such that when each of the input radiation images of the chests 1R is inputted, a radiation image 52 compensated for image quality degradation and only representing the bone portion of each of the subject chests 1R is outputted with each of the teacher chest radiation images 38 as the teacher.

After the teacher trained filter 42 is obtained, for a given subject of adult female chest 3R, a radiation image 76′ which is the same type as the input radiation image 76 is generated, which is then inputted to the teacher trained filter 42 to output a radiation image 62 compensated for image quality degradation and only representing the bone portion of the chest 3R. This may improve the quality of a radiation image representing the subject without increasing the radiation dose to the subject.

Here, the radiation image 76′ is generated through substantially the same procedure as that for generating the input radiation image 76 for the given subject of chest 3R. The radiation image 76′ is an image having less noise as a whole from the high frequency side to the low frequency side, although including more soft components as the frequency increases, and comparable to the input radiation image 76.

Note that the particular region of the subject described above may be a motion artifact arising from the difference in the imaging timing of the high energy image and low energy image. The particular region of the subject representing the motion artifact component, which is a positional variation component between the two images, may be deemed as a region that has moved within the subject during a time period (e.g., 0.1 seconds) from the time when the high energy image (or low energy image) is recorded to the time when the low energy image (or high energy image) is recorded. For example, if the subject is a chest living tissue, the particular region of the subject may be deemed to a region that has moved according to beating of the heart during a time period from the time when the high energy image (or low energy image) is recorded to the time when the low energy image (or high energy image) is recorded.

FIG. 12 illustrates a motion artifact produced in a bone portion image representing a chest.

As illustrated in FIG. 12, a motion artifact Ma may sometimes be produced according to heartbeat in a bone portion image FK representing an adult female chest, which is an energy subtraction image formed by a weighted subtraction using a high energy image and a low energy image obtained by radiography with radiations having different energy distributions from each other. Such motion artifact needs to be removed from the radiation image and may be removed in the following manner. That is, forming a radiation image with the motion artifact Ma, which is the particular region described above, highlighted by passing through the teacher trained filter, and subtracting so generated radiation image from the bone portion image FK, thereby a bone portion image removed of motion artifact components representing the motion artifact Ma may be generated.

As described above, the particular region may be regarded as a region that changed its position between the high energy image and low energy image. Further, the highlighted particular region described above may be an unnecessary region (defective region). In such a case, a radiation image representing the unnecessary region may be subtracted from a radiation image including both a necessary region and the unnecessary region to obtain a desired radiation image removed of the unnecessary region and including only the necessary region.

The method for obtaining the radiation images described above may use either the single shot radiography or dual shot radiography.

Further, in the radiography for obtaining a high energy image and a low energy image, the radiation dose used for obtaining the low energy image may be greater or smaller than a radiation dose used for obtaining the high energy image. In the radiation image processing method described above, if noise suppression is the intended purpose, then it is preferable that the dose of radiation used for obtaining the high energy image be greater than the dose of radiation used for obtaining the low energy image.

Still further, neural networks, relevance vector machine, or the like may be employed in the regression training method other than the support vector machine.

Where the teacher image of each of the subjects is obtained by radiography using a radiation dose greater than that used for obtaining each of the input radiation images, the radiation dose irradiated onto a single subject may exceed an acceptable value. By restricting the sum of radiation doses irradiated onto the subject during a predetermined time period, however, the radiography of the subject for obtaining the teacher image may be performed using a high radiation dose.

Hereinafter, the radiation image processing method representing aforementioned embodiments will be described.

The radiation image processing method representing the embodiments described above is a method for obtaining a high energy image and a low energy image by radiography of a subject using radiations having different energy distributions from each other and obtaining a radiation image with a particular region of the subject highlighted using the high energy image and low energy image.

According to the method described above, with respect to each of a plurality of subjects, an input radiation image constituted by two or more different types of radiation images obtained by radiography of each of the subjects with radiations having different energy distributions from each other, or one or more types of input radiation images generated using a high energy image and a low energy image are provided first. Then, teacher radiation images having less image quality degradation with the particular region of the subjects highlighted are provided. Thereafter, a teacher trained filter is obtained, which has learned such that when the input radiation image of each of the subjects is inputted, a radiation image compensated for image quality degradation with the particular region of the subject highlighted is outputted.

Thereafter, for a given subject of the same type as the subject described above, a radiation image of the same type as the input radiation image is generated through processing which is similar to that when the input radiation image is generated. That is, a radiation image of the given subject corresponding to the input radiation image is generated through radiography of the given subject under substantially the same imaging conditions as those when the input radiation image is generated and substantially the same image processing as that performed on the input radiation image. Then, the radiation image of the subject corresponding to the input radiation image is inputted to the teacher trained filter, thereby a radiation image representing a radiographic image of the subject in which image quality degradation is compensated and the particular region thereof enhanced is obtained.

As for the input radiation image, (i) a high energy image and a low energy image obtained by radiography of each of a plurality of subjects of the same type with radiations having different energy distributions from each other (ii) the high energy image and one or more types of energy subtraction images formed by a weighted subtraction using the high energy image and low energy image, (iii) the low energy image and the one or more types of energy subtraction images, and (iv) only the one or more types of energy subtraction images may be used.

As illustrated in FIGS. 1 and 2, the radiation image processing apparatus 110 for implementing the radiation image processing method of the present invention includes: a filter obtaining section Mh1 (FIG. 1) for obtaining the teacher trained filter 40 trained with an input radiation image 11 constituted by a high energy image 11H and a low energy image 11L obtained by the radiography 10 of each of a plurality of subjects 1P of the same type with radiations having different energy distributions from each other, and a teacher radiation image 33 obtained by the radiography 30 of each of the subjects 1P, having less image quality degradation than either of the high energy image and low energy image, and representing the particular region Px of the subject 1P described above highlighted, such that in response to input of each of the input radiation images 11, a radiation image of the subject compensated for image quality degradation with the particular region thereof highlighted is outputted with each of the teacher radiation images corresponding to each of the subjects as the teacher; a same type image generation section Mh2 (FIG. 2) for generating a radiation image 21 of the same type as the input radiation image 11 by performing radiography 20 of a given diagnostic target subject 3P of the same type as the subject 1P; and a region-enhanced image forming section Mh3 (FIG. 2) for forming a diagnostic radiation image 60 compensated for image quality degradation occurred in the radiation image of the subject 3P with the particular region Px of the subject 3P highlighted by inputting the radiation image 21 to the teacher trained filter 40 obtained in the manner as described above.

The operation of the radiation image processing apparatus 110 is identical to the radiation image processing method already described, so that it will not be elaborated upon further here. Note that each of the images used in the filter obtaining section Mh1, same type image generation section Mh2, and region-enhanced image forming section Mh3 may be either an image itself or image data representing the image.

The teacher trained filter is not a filter trained with respect to each of the small regions, but provided only one type for each frequency range and all of the small regions are processed by the single filter. The training method of the filter is that training samples are extracted from various small regions of a single (or small number) radiation image and the multitudes of samples are treated at the same time as a mass. That is, training samples formed of, for example, around clavicles of Mr. A, around lower side of the clavicles of Mr. A, around the contour of the ribs of Mr. A, around the center of the ribs of Mr. A, and the like are learned at a time. Further, the characteristic amount for filter input is 25 pixels, but the teacher which is an output corresponding to the 25 pixels is not 25 pixels but a single pixel in the center of the small region.

Further, a program for performing the function of the radiation image processing apparatus of the present invention may be installed on a personal computer, thereby causing the personal computer to perform the operation identical to that of the embodiment described above. That is, the program for causing a computer to perform the radiation image processing method of the embodiment described above corresponds to the computer program product of the present invention.

Hereinafter, other radiation image processing methods, apparatuses, and programs according to the present invention will be described.

The radiation image processing method according to a fourth embodiment of the present invention uses two types of images, a plain radiation image representing a subject and a region identification image representing a boundary between a particular region and the other portion within the subject generated from the plain radiation image as an input radiation image.

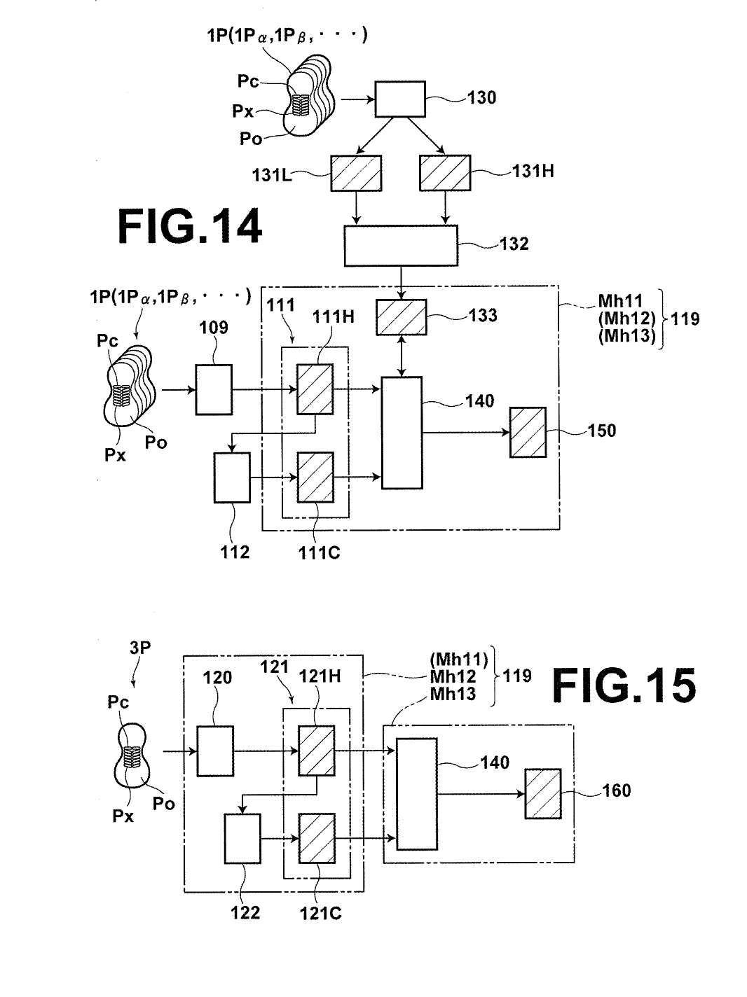

FIG. 14 illustrates a procedure for obtaining a teacher trained filter used for the radiation image processing method according to the fourth embodiment, and FIG. 15 illustrates a procedure of obtaining a diagnostic radiation image using the teacher trained filter described above. Note that each of the hatched portions in the drawings indicates an image or image data representing the image.

According to the radiation image processing method of the fourth embodiment, an input radiation image 111 constituted by a training subject image 111H representing a plain radiographic image of each of the adult male chests 1P and a training region identification image 111C representing a boundary Pc between a bone portion Px, which is a particular region of each of the chests 1P, and the other portion Po different from the bone portion Px is provided. The training subject image 111H is obtained by plain radiography 109 of each of a plurality of adult male chest subjects of the same type 1Pα, 1Pβ, - - - (hereinafter, also collectively referred to as the “chests 1P”), and the training region identification image 111C is obtained by performing a boundary extraction 112 on the subject image 111H.

The plain radiography described above obtains a radiation image (plain radiation image) of the subject by radiography that irradiates one type of radiation once onto the subject, without using radiations having different energy distributions from each other.

Further, with respect to each of the subjects 1P, a teacher radiation image with a bone portion Px, which is a particular region of each of the chests 1Pα, 1Pβ, - - - , highlighted is provided, which is obtained by radiography of each of the chests 1P.

Then, a teacher trained filter 140 trained with the input radiation image 111 as the target and the teacher radiation image as the teacher.

That is, the teacher trained filter 140 is obtained by training the filter using each pair of input radiation image 111 and teacher radiation image 133 provided for each of the chests 1Pα, 1Pβ, - - - , such that when each of the input radiation images 111 generated for each of the subjects 1Pα, 1Pβ, - - - is inputted, a radiation image 150 representing the radiation image of each of the subjects 1P compensated for image quality degradation occurred in the input radiation image 11 with the particular region Px thereof highlighted is outputted with the teacher radiation image 133 corresponding to each of the subjects 1P as the teacher. More specifically, the teacher trained filter 140 is obtained by training the filter using a pair of input radiation image 111 and teacher radiation image 133 provided for, for example, the chest 1Pα, such that when the input radiation image 111 corresponding to the subject 1Pα is inputted, a radiation image 150 representing the radiation image of the subject 1Pα with the particular region Px thereof highlighted is outputted with the teacher radiation image 133 corresponding to the subject 1Pα as the teacher.

Each of the teacher radiation images 133 is an energy subtraction image representing the bone portion obtained by weighted subtraction 132, i.e., an energy subtraction of a high energy image 131H and a low energy image 131L obtained by radiography 130 of each of the subjects 1P using higher radiation doses than the radiation doses used by the radiography 10 of each of the subjects 1P for generating each of the input radiation images 11.

After obtaining the teacher trained filter 140, plain radiography 120 is performed for a given single diagnostic target subject 3P of the same type as the subject 1P to generate a radiation image 121 of the same type as the input radiation image 111, as illustrated in FIG. 15.

That is, a radiation image 121 constituted by a diagnostic target subject image 121H and a diagnostic target region identification image 121C is generated. The diagnostic target subject image 121H is a plain radiation image representing the chest 3P obtained by plain radiography 120 of the chest 3P, and the diagnostic target region identification image 121C is obtained by performing a boundary extraction on the subject image 121H and represents the boundary Po between the bone portion Px, which is a particular region of the chest 3P, and the other portion Po, which is different from the bone portion Px.

Then, a diagnostic radiation image representing the given subject of chest 3P with the particular region Px thereof highlighted is formed by inputting the diagnostic target subject image 121H and region identification image 121C to the teacher trained filter 140 obtained in the manner as described above. The diagnostic radiation image is an image in which mixing of a false image of a region other than the bone portion into the image representing the bone portion is suppressed.

The radiation image 121 of the same type as the input radiation image 111 is obtained based on plain radiography 120 of the given chest 3P under substantially the same imaging conditions as the radiography 109. That is, the input radiation image 111 and the radiation image 121 are obtained by radiography in which radiations having substantially the same energy distribution with substantially the same radiation dose are irradiated to the subject . Further, the operation performed in the boundary extraction 122 is identical to that performed in the boundary extraction 112.

Each of the chests 1Pα, 1Pβ, - - - used for generating the input radiation images 111 and teacher radiation images, and the single chest 3P given when generating the diagnostic target image 160 are of the same type. That is, the chests 1Pα, 1Pβ, - - - , and 3P are living tissues having substantially the same shape, structure, and size with each of the regions thereof having the same radiation attenuation coefficient, and the like. Further, the bone portion Px, which is the particular region described above, is a region having a particular radiation attenuation coefficient different from the other portion Po of the chest described above.

Further, the boundary extraction 112 (boundary extraction 122) discriminates, with respect to each of small regions of the plain radiation image 111H (plain radiation image 121H), whether the tissue to which each of the small regions mainly belongs is bone or other than bone, and obtains the region identification image 111C (region identification image 121C) by integrating the discrimination result of each of the small regions.

As described above, according to the radiation image processing method of the fourth embodiment, a bone image more clearly representing a boundary between a particular region of a diagnostic target subject and the other portion different from the particular region may be obtained without increasing the radiation dose to the subject.

By using an image with less image quality degradation than the subject image 111H as the teacher image 133 in the training for obtaining the teacher trained filter 140, a diagnostic radiation image compensated for image quality degradation occurred in the subject image 121H of a given subject with the particular region Px thereof highlighted may also be formed.

The radiation image processing method of the present invention, however, may be applicable regardless of the degree of image quality degradation. That is, for example, even when the teacher radiation image 133 has image quality degradation identical to that of the subject image 111H, the radiation image processing method of the present invention is applicable.

Hereinafter, the radiation image processing method according to a fifth embodiment of the present invention will be described. The radiation image processing method uses three different types of images: a high energy subject image, a quality degraded bone portion image formed by a weighted subtraction using the high energy subject image and a low energy image, and a region identification image representing a boundary between a particular region of the subject and the other portion formed using the high energy image and quality degraded bone portion image.

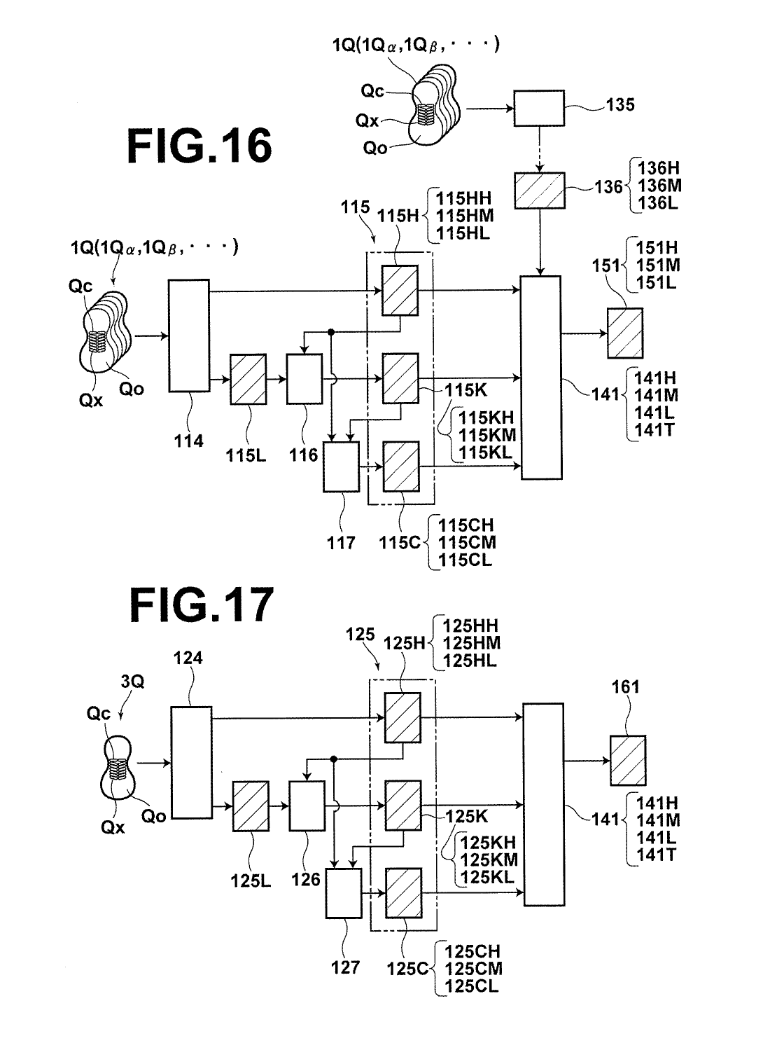

FIG. 16 illustrates a procedure for obtaining a teacher trained filter used for the radiation image processing method according to the fifth embodiment, and FIG. 16 illustrates a procedure of the radiation image processing method for obtaining a diagnostic radiation image using the teacher trained filter described above.

According to the radiation image processing method of the fifth embodiment, an input radiation image 115 is provided first, which is generated using a high energy image 115H and a low energy image 115L obtained by radiography 114 of each of a plurality of adult female chest subjects of the same type 1Qα, 1Qβ, . . . (hereinafter, also collectively referred to as the “chests 1Q”) with radiations having different energy distributions from each other.

The input radiation image 115 includes three different types of training images: the high energy image 115H which is a subject image, a bone portion image 115K which is a quality degraded subject image formed by a weighted subtraction 116 using the high energy image 115H and low energy image 115L, and a region identification image 115C representing a boundary Qc between a bone portion Qx of each of the chests 1Q and the other portion Qo different from the bone portion Qx formed by a boundary extraction 117 using the high energy image 115H and bone portion image 115K.

The radiography 114 is radiography in which a higher radiation dose is irradiated when obtaining the high energy image 115H than that when obtaining the low energy image 115L. Accordingly, the high energy image 115H is an image with less noise, and the low energy image 115L is an image having more noise than the high energy image. Further, the image quality of the bone portion image 115K generated using the low energy image 115L having much noise is degraded.

As for the boundary extraction 117, any of various known image processing methods for determining the boundary between a particular region and the other region may be used.

Along with the provision of the input radiation image 115, a teacher radiation image 136 having less image quality degradation than the training high energy image 115H obtained by radiography of each of the chests 1Q, and representing each of the chests 1Q with a bone portion Qx highlighted is provided with respect to each of the chests 1Qα, 1Qβ, - - - .

The teacher subject image 136 representing the bone portion may be generated using any known method. For example, it may be a bone portion image obtained by a weighted subtraction using high and low energy images representing each of the chests 1Q obtained by radiography 135 of each of the chests 1Q with radiation doses greater than those used for the respective radiography with respect to each of the chests 1Q when each of the input radiation images 115 is generated.

Next, a teacher trained filter 141 trained with the input radiation image 115 as the target and the teacher radiation image 136 as the teacher is obtained.

That is, the teacher trained filter 141 is a trained filter such that when the training high energy image 115H, bone portion image 115K and region identification image 115C are inputted with respect to each of the subject chests 1Q, a radiation image 151 compensated for image quality degradation with the bone portion of each of the chests 1Q, which is the particular region described above, highlighted is outputted with each of the teacher radiation images 136 as the teacher. More specifically, the teacher trained filter 141 may be obtained by training the filter using a pair of input radiation image 115 constituted by several different types of images provided and the teacher radiation image 136 corresponding to each of the chests 1Qα, 1Qβ, - - - .

After the teacher trained filter 141 is obtained, for a diagnostic target adult female chest 3Q which is the same type as the chest 1Q, a radiation image 125 which is the same type as the input radiation image 115 is generated, which is then inputted to the teacher trained filter 141 to form a radiation image compensated for image quality degradation with the bone portion Qx, which is the particular region of the given chest 3Q, highlighted. The radiation image 125 is a radiation image in which mixing of a false image of a region other than the bone portion into the image representing the bone portion is suppressed.

The radiation image 125 is a radiation image generated using a high energy image 125H and a low energy image 125L representing the chest 3Q obtained by radiography 124 of the chest 3Q.

That is, the radiation image 125 is formed of three different types of images: the high energy image 125H which is the diagnostic target subject image, a bone portion image 125K which is a quality degraded diagnostic target subject image formed by a weighted subtraction 126 using the high energy image 125H and low energy image 125L, and a region identification image 125C representing a boundary Qc between a bone portion Qx of each of the chests 1Q and the other portion Qo different from the bone portion Qx formed by a boundary extraction 127 using the high energy image 125H and bone portion image 125K.

As described above, according to the radiation image processing method of the fifth embodiment, the quality of the radiation image representing a diagnostic target subject image may be improved without increasing the radiation dose to the subject.

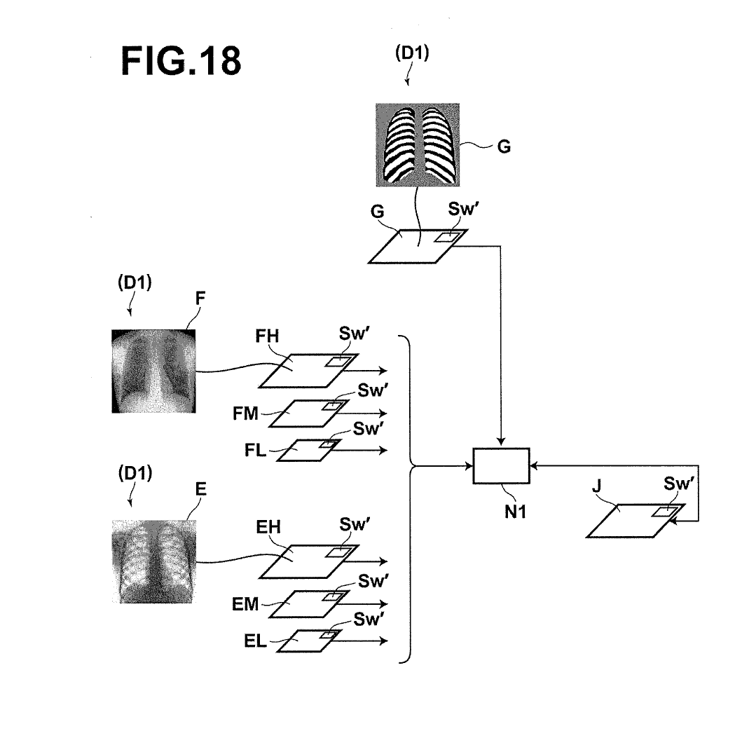

An example method for performing the boundary extractions 117, 127 will now be described. As described above, any known method may be used for the boundary extraction. FIG. 18 illustrates a boundary extraction process.

In the boundary extraction described above, two classes of a bone portion and a region other than the bone portion (e.g., an image region formed of a value −1 and an image region formed of a value +1) are determined as the class to be discriminated.

A bone portion image E representing a radiation image of a chest subject D1 obtained by a weighted subtraction using high and low energy images obtained by radiography of the subject D1, and the high energy image F are used as the input radiation image.

Further, a region identification image G labeled, by manual input, with the two classes for the discrimination between the bone portion and the region other than the bone portion is used as the teacher radiation image. Then, a discrimination filter N1 is obtained by training the filter such that when the bone portion image E and high energy image F are inputted to the discrimination filter N1, a region identification image J representing a boundary between the bone portion and the region other than the bone portion of the chest D1 is formed with the region identification teacher image G as the teacher.

The region identification image J is an image similar to the region identification teacher image G.

Further, the training of the discrimination filter N1 is performed, for example, by setting a sub-window Sw′ on a corresponding small region of each of the bone portion image E, high energy image F, and region identification image G, and setting a characteristic amount, which is the pixel values within the sub-window Sw′, and the class corresponding to the characteristic amount.

The characteristic amount described above is the pixel value of a rectangular area of 5×5 pixels within the sub-window Sw′ on each of the images of different spatial frequency ranges from each other (bone portion images EH, EM, EL, and high energy images FH, FM, FL) obtained by performing multi-resolution conversions on the bone image E and high energy image F. If the number of spatial frequency ranges is three, then the characteristic amount is represented by 75 pixel values (3×5×5=75), and if the number of spatial frequency ranges is eight, it is represented by 200 pixel values (8×5×5=200). Then, using a support vector machine (SVM) to be described later, training for discriminating the two classes, i.e., the bone portion and the region other than the bone portion is performed.

When a bone portion image and a high energy image of the same subject are inputted, the boundary extraction 117 or 127 including the discrimination filter N1 trained in the manner as described above forms a region identification image representing a boundary between the bone portion and the region other than the bone portion of the subject.

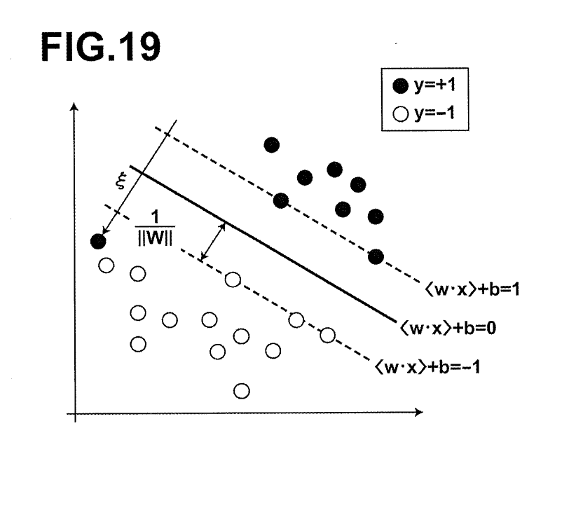

Hereinafter, description will be made on how to discriminate the two classes (bone portion and region other than the bone portion) based on a support vector machine (SVM). FIG. 19 illustrates discrimination of two classes based on support vector regression.

For details of the support vector machine, refer to “An introduction to Support Vector Machine”, by Nello Cristianini and John Shawe-Taylor, Cambridge University Press 2000, UK.

For a problem of learning the following function for discriminating two classes y={−1, 1} corresponding to an n-dimensional characteristic vector x, first considering a case in which the discrimination function is linear.

$$f ( x ) = {\sum }_{i = 1}^{l} {α}_{i} 〈 {x}_{i} \cdot x 〉 + b \qquad ( 6 )$$

Here, the geometric distance (margin) between the discrimination face and the training sample is

$$\frac{1}{‖ w ‖} \qquad ( 7 )$$

The support vector machine learns a discrimination face that maximizes the margin under the constraint that all of the training samples are correctly separated by the discrimination function.

$$Minimization \frac{1}{2} {‖ w ‖}^{2} + C {\sum }_{i = 1}^{k} {ξ}_{i} , \\ Condition {y}_{i} ( 〈 w \cdot {x}_{i} 〉 + b ) \geq 1 - {ξ}_{i} , \\ {ξ}_{i} \geq 0 , i = 1 , … , l . \qquad ( 8 )$$

where, ξ is the moderator that allow training samples not correctly discriminated. C is the parameter for setting a tradeoff between the complexity of the model and moderation of the constraint.

The problem described above is equivalent to solving the following dual problem, and from the nature of the convex quadratic program problem, a global solution may be invariably obtained.

$$Maximization {\sum }_{i = 1}^{l} {α}_{i} - \frac{1}{2} {\sum }_{i , j = 1}^{l} {α}_{i} {α}_{j} {y}_{i} {y}_{j} 〈 {x}_{i} \cdot {x}_{j} 〉 \\ Condition 0 \leq {α}_{i} \leq C , {\sum }_{i = 1}^{l} {α}_{i } {y}_{i} = 0 , i = 1 , … , l . \qquad ( 9 )$$

The discrimination function obtained by solving the problem is expressed as

$$f ( x ) = {\sum }_{i = 1}^{l} {α}_{i} {y}_{i} 〈 {x}_{i} \cdot x 〉 + b \qquad ( 10 )$$

This function is a linear function. In order to extend it to a nonlinear function, it is only necessary to project the input x onto a higher order characteristic space Φ(x) and to regard the vector Φ(x) in the characteristic space as the input x(x→Φ(x)). In general, the projection onto a higher order space accompanies largely increased amount of calculations. But, replacement of an inner product term appearing in the formula to be optimized with a kernel function that satisfies the relationship of K(x, y)=<Φ(x), Φ(y)> may provides, with the input order calculations, the same calculation result as that obtained after projecting to a higher order space. As for the kernel function, RBF kernel function, polynomial kernel, or sigmoid kernel may be used.

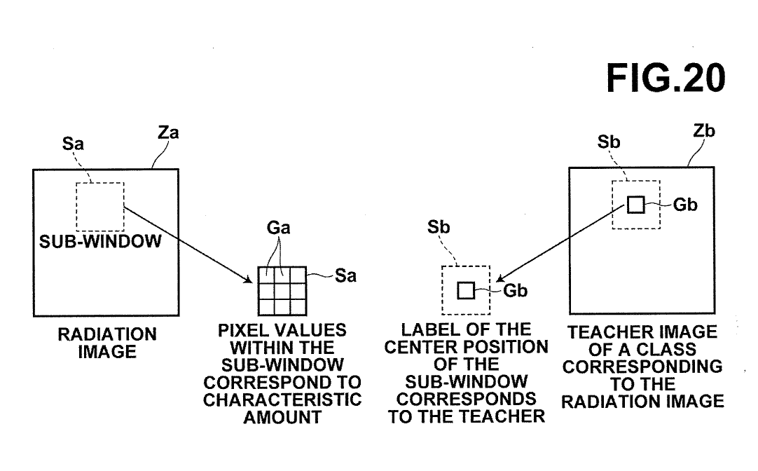

FIG. 20 illustrates how to set a sub-window in a target radiation image for boundary extraction and a teacher image of a class corresponding to the radiation image.

A sub-window Sa is set to a discrimination target radiation image Za, and a value of each of the pixels Ga within the sub-window is used as the characteristic amount. In a teacher image Zb of a class corresponding to the radiation image Za, the class label in the center pixel Gb within a sub-window Sb set at a place corresponding to the sub-window Sa is used as the teacher data.

A pair of one-dimensional output values for n-dimensional input (characteristic amounts) is used as a training sample. The training of the discrimination filter is performed using a mass of the training samples.

The discrimination result of the trained discrimination filter is the result of a single pixel. Accordingly, a region identification image is obtained by scanning all of the pixels with the discrimination filter. This is true of support vector regression to be described later. As will be described later, when generating a bone portion image, a non-liner filtering is performed to obtain a corresponding value for bone portion at each pixel position of a high spatial frequency range image, an intermediate spatial frequency range image, and a low spatial frequency range image.

Next, acqusition of the teacher trained filter 141 will be described in detail.

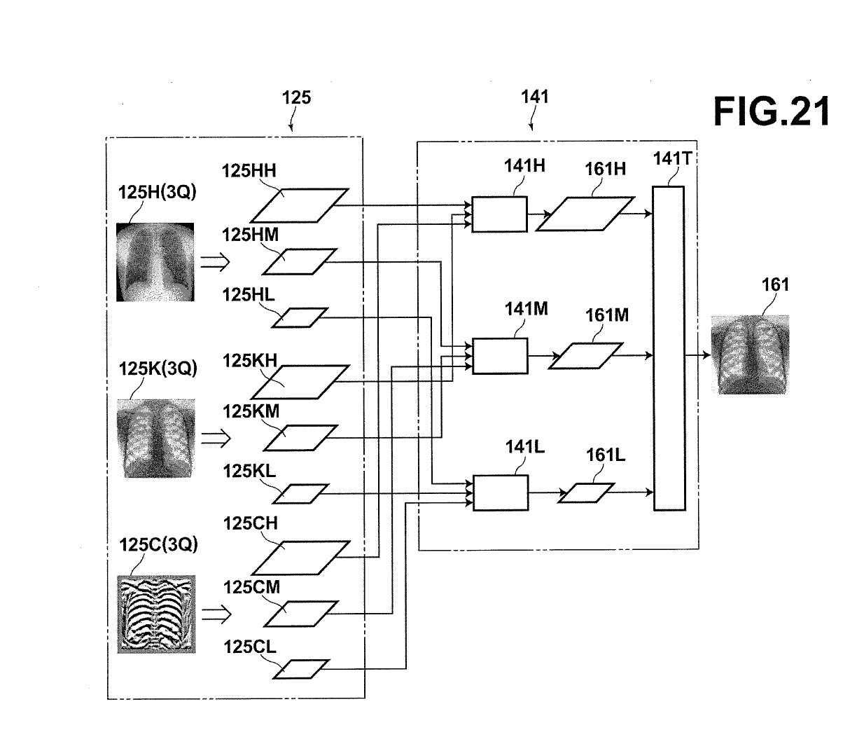

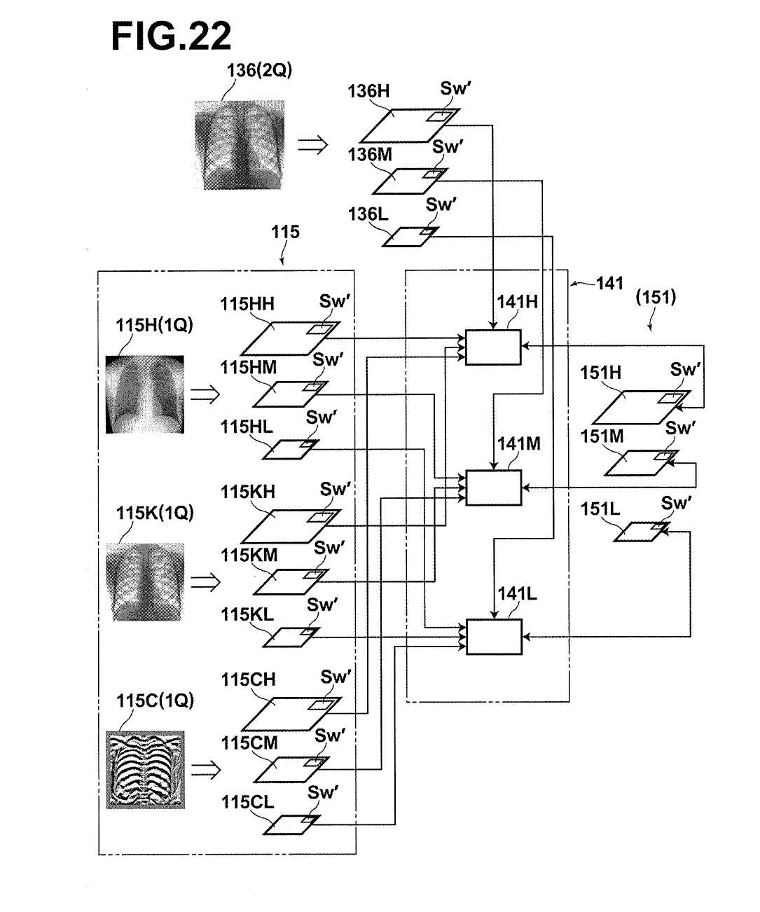

FIG. 21 illustrates how to generate a diagnostic radiation image for a given subject by inputting radiation images of respective spatial frequency ranges to a teacher trained filter. FIG. 22 illustrates how to obtain a teacher trained filter with respect to each spatial frequency range.

Here, it is assumed that the input radiation image is constituted by a plurality of region identification images of different resolutions from each other generated from a region identification image obtained by radiography of a subject and boundary extraction, and subject images of respective spatial frequency ranges representing the subject. Further, it is assumed that the teacher radiation image is obtained by radiography of a subject of the same type as the subject described above, and constituted by a plurality of teacher radiation images of the respective spatial frequency ranges having less image quality degradation than the subject images described above and representing the subject with the same region as a particular region of the subject highlighted.

That is, in order to obtain, from a region identification image of one type of resolution, a plurality of region identification images of different resolutions from each other, which are lower than the one type of resolution, a reduction operation is performed on the one type region identification image in which the number of pixels is reduced, thereby obtaining a low resolution region identification image. This may cause the resolutions of the respective region identification images to correspond to the different spatial frequency ranges from each other of the subject images. A multi-resolution conversion method for obtaining, from a subject image of one type of resolution, a plurality of subject images of different resolutions from each other, which are lower than the one type of resolution, will be described later.

The teacher trained filter is a filter trained with the input radiation image constituted by a plurality of region identification images of different resolutions from each other and subject images of different spatial frequency ranges from each other as the target and a plurality of teacher radiation images of different spatial frequency ranges from each other as the teacher.

Then, for a given diagnostic target subject of the same type as the subject described above, a plurality of radiation images of different spatial frequency ranges from each other, which are the same type of the input radiation image, is generated. Then, the plurality of radiation images of different spatial frequency ranges from each other is inputted to the teacher trained filter, and a plurality of radiation images of the different spatial frequency ranges from each other compensated for image quality degradation with the particular region of the given subject highlighted is formed by the teacher trained filter. Then, the plurality of radiation images is combined together to generate a single radiation image.

That is, the teacher trained filter 141 may be configured to generate a plurality of diagnostic target radiation images of the respective spatial frequency ranges 161H, 161M, 161L based on input of radiation images of different spatial frequency ranges from each other obtained by performing multi-resolution conversions on a high energy image 125H and a bone portion image 125K of a given diagnostic target subject 3Q, and region identification images 125C of different spatial frequency ranges from each other, and to obtain a diagnostic radiation image 161 by combining the plurality of generated radiation images 161H, 161M, 161L, as illustrated in FIG. 21.

Here, the teacher trained filter 141 includes a high frequency range teacher trained filter 141H, an intermediate frequency range teacher trained filter 141M, a low frequency range teacher trained filter 141L, an image composition filter 141T, and the like.

As illustrated in FIG. 22, the teacher radiation images 136H, 136M, 136L with respect to each of the spatial frequency ranges representing the chest portion 1Q provided for generating the teacher trained filter 141 are images compensated for image quality degradation and mainly representing the bone portion, which is the particular region described above, obtained by performing a multi-resolution conversion on a radiation image 136 (bone portion high resolution image).

Further, each of the bone portion images 115KH, 115KM, 115KL which are radiation images of the respective spatial frequency ranges, and each of the high energy images 115HH, 115HM, 115HL representing the chest portion 1Q provided for generating the teacher trained filter 141 are obtained by performing a multi-resolution conversion on each of the bone portion image 115K and high energy image 115H as in the teacher radiation image 136.

Each of the region identification images 115CH, 115CM, 115CL of the respective spatial frequency ranges are images obtained by performing reduction operations.

That is, a multi-resolution conversion is performed on the teacher radiation image 136 to form a radiation image representing a high frequency range (teacher high frequency range image 136H), a radiation image representing an intermediate frequency range (teacher intermediate frequency range image 136M), and a radiation image representing a low frequency range (teacher low frequency range image 136L).

Further, a multi-resolution conversion is performed on the teacher training bone portion image 115K to form a radiation image representing a high frequency range (bone portion high frequency range image 115KH), a radiation image representing an intermediate frequency range (bone portion intermediate frequency range image 115KM), and a radiation image representing a low frequency range (bone portion low frequency range image 115KL).

Still further, a multi-resolution conversion is performed on the high energy image 115H to form a radiation image representing a high frequency range (high energy high frequency range image 115HH), a radiation image representing an intermediate frequency range (high energy intermediate frequency range image 115HM), and a radiation image representing a low frequency range (high energy low frequency range image 115HL).

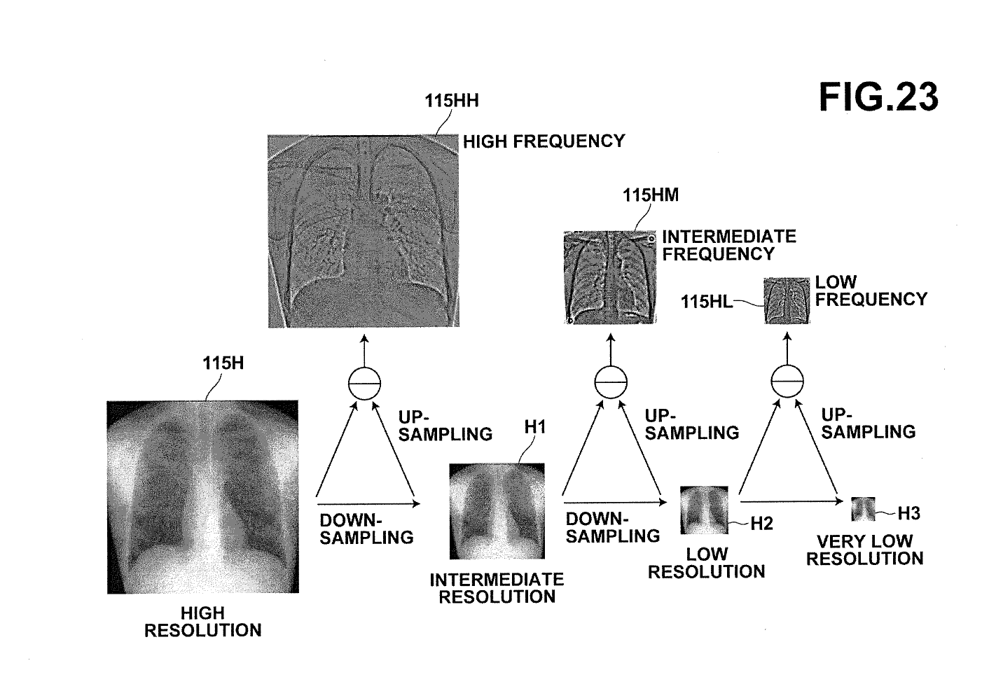

FIG. 23 illustrates a multi-resolution conversion of an image.

For example, the high energy high frequency range image 115HH is an image obtained by up-sampling the high energy image 115H (high energy high resolution image) and a high energy intermediate resolution image H1 obtained by down-sampling the high energy image 115H, as illustrated in FIG. 23.

In the down-sampling described above, Gaussian lowpass filtering with σ=1, and ½ skipping of the high energy image 115H are performed. The up-sampling is performed through a cubic B-spline interpolation.

The high energy intermediate frequency range image 115HM is obtained by up-sampling the high energy intermediate resolution image H1 and a high energy low resolution image H2 obtained by down-sampling the high energy intermediate resolution image H1 as in the case of the high energy high frequency range image 115HH.

The high energy low frequency range image 115HL is obtained by up-sampling the high energy low resolution image H2 and a high energy very low resolution image H3 obtained by down-sampling the high energy low resolution image H2, as in the case of the high energy high frequency range image 115HH or high energy intermediate frequency range image 115HM.

Also, for the bone portion image E, a bone portion high frequency range image KH, a bone portion intermediate frequency range image KM, and a bone portion low frequency range image KL are obtained in the manner as described above.

Reduction operations are performed on the training region identification image 115C in which the number of pixels is reduced so that the resolution of the region identification image 115C corresponds to that of each of the images described above. This generates an intermediate resolution radiation image (boundary intermediate frequency range image 115CM) and a low resolution radiation image (boundary low frequency range image 115CL) from the high resolution region identification image 115C (boundary high frequency range image 115CH).

The method of obtaining the boundary high frequency range image 115CH, boundary intermediate frequency range image 115CM, and boundary low frequency range image 115CL is not limited to the aforementioned method in which reduction operations are performed on the high resolution image to obtain low resolution images. For example, from an image of particular spatial frequency range, a region identification image corresponding to the spatial frequency range may be generated for each of the resolutions different from each other.

Further, the teacher trained filter 141 is obtained for each of the three spatial frequency ranges described above. That is, the high frequency range teacher trained filter 141H, intermediate frequency range teacher trained filter 141M, and low frequency range teacher trained filter 141L are obtained through training with respect to each of the spatial frequency ranges.

Hereinafter, a description will be made of a case in which the high frequency range teacher trained filter 141H is obtained through training.

As illustrated in FIG. 22, a sub-window Sw′ is set to each of the training bone portion high frequency range image 115KH, training high energy high frequency range image 115HH, boundary high frequency range image 115CH, which is a training high resolution region identification image, and teacher high frequency range image 136H, which is a small rectangular area of 5×5 pixels (25 pixels in total) corresponding to each other.

Then, with respect to a characteristic amount constituted by 25 pixel values forming the sub-window Sw′ of each of the bone portion high frequency range image 115KH, high energy high frequency range image 115HH, and boundary high frequency range image 115CH, a training sample, with the value of the center pixel of the sub-window Sw′ of the teacher high frequency range image 136H as the target value, is extracted. In this way, while moving the sub-windows, a plurality of training samples is extracted. The high frequency range teacher trained filter 141H is obtained through training using the extracted samples of, for example, 10,000 types.

The high frequency range image 151H, intermediate frequency range image 151M and low frequency range image 151L to be described later are images similar to the teacher high frequency range image 136H, teacher intermediate frequency range image 136M, and teacher intermediate frequency range image 136L respectively.

The high frequency range teacher trained filter 141H or the like is a filter that has learned a regression model using support vector regression described hereinbelow. The regression model is a non-linear high frequency range filter that outputs a high frequency range image 151H compensated for image quality degradation and mainly representing the bone portion, which is the particular region described above, according to inputted characteristic amount (image represented by the 25 pixels described above) of the bone portion high frequency range image 115KH, inputted characteristic amount (image represented by the 25 pixels described above) of the high energy high frequency range image 115HH, and inputted characteristic amount (image represented by the 25 pixels described above) of the boundary high frequency range image 115CH.

The intermediate frequency range teacher trained filter 141M is obtained through training, which is similar to that described above, using the bone portion intermediate frequency range image 115KM, high energy intermediate frequency range image 115HM, boundary intermediate frequency range image 115CM, and teach intermediate frequency range image 136M.

Further, the low frequency range teacher trained filter 141L is obtained through training, which is similar to that described above, using the bone portion low frequency range image 115KL, high energy low frequency range image 115HL, boundary low frequency range image 115CL, and teach low frequency range image 136L.

As described above, the training of the regression model is performed with respect to each of the spatial frequency ranges, thereby the teacher trained filter 141, constituted by the teacher trained filter 141H, teacher trained filter 141M, and teacher trained filter 141L, are obtained.

As illustrated in FIG. 21, an image with respect to each of the frequency ranges obtained by performing a multi-resolution conversion on each of the bone portion image 125K, high energy image 25H, and region identification image 125C, constituting the diagnostic target image 125 generated for the given diagnostic target adult female chest 3Q of the same type as the input radiation image 115 is inputted to the teacher trained filter 141 obtained in the manner as described above.

That is, the bone portion high frequency range image 125KH, bone portion intermediate frequency range image 125KM and bone portion low frequency range image 125KL obtained by performing a multi-resolution conversion on the bone portion image 125K, the high energy high frequency range image 125HH, high energy intermediate frequency range image 125HM and high energy low frequency range image 125HL obtained by performing a multi-resolution conversion on the high energy image 125H, and the boundary high frequency range image 125CH, boundary intermediate frequency range image 125CM and boundary low frequency range image 125CL obtained by performing reduction operations on the region identification image 125C are inputted to the teacher trained filter 141.

Then, the teacher trained filters 141H, 141M, 141L, to which images of the respective spatial frequency ranges of the bone portion image 125K, high energy image 125H, and region identification image 125C are inputted, estimate diagnostic target images 161H, 161M, 161L of the respective spatial frequency ranges, and combine the estimated diagnostic target images 161H, 161M, 161L together through the image composition filter 141T, thereby obtaining the diagnostic radiation image 161.

That is, when the bone portion high frequency range image 125KH, high energy high frequency range image 125HH, and boundary high frequency range image 125CH are inputted to the high frequency range teacher trained filter 141H, the high frequency range diagnostic target radiation image 161H compensated for image quality degradation and mainly representing the bone portion, which is the particular region described above, is formed.

When the bone portion intermediate frequency range image 125KM, high energy intermediate frequency range image 125HM, and boundary intermediate frequency range image 125CM are inputted to the intermediate frequency range teacher trained filter 141M, the intermediate frequency range diagnostic target radiation image 161M compensated for image quality degradation and mainly representing the bone portion, which is the particular region described above, is formed.

Further, when the bone portion low frequency range image 125KL, high energy low frequency range image 125HL, and boundary low frequency range image 125CL are inputted to the low frequency range teacher trained filter 141L, the low frequency range diagnostic target radiation image 161L compensated for image quality degradation and mainly representing the bone portion, which is the particular region described above, is formed.

Then, the high frequency range diagnostic target radiation image 161H, intermediate frequency range diagnostic target radiation image 161M, and low frequency range diagnostic target radiation image 161L formed in the manner as described above are combined together by the image composition filter 141T, thereby the diagnostic radiation image 161 is generated.

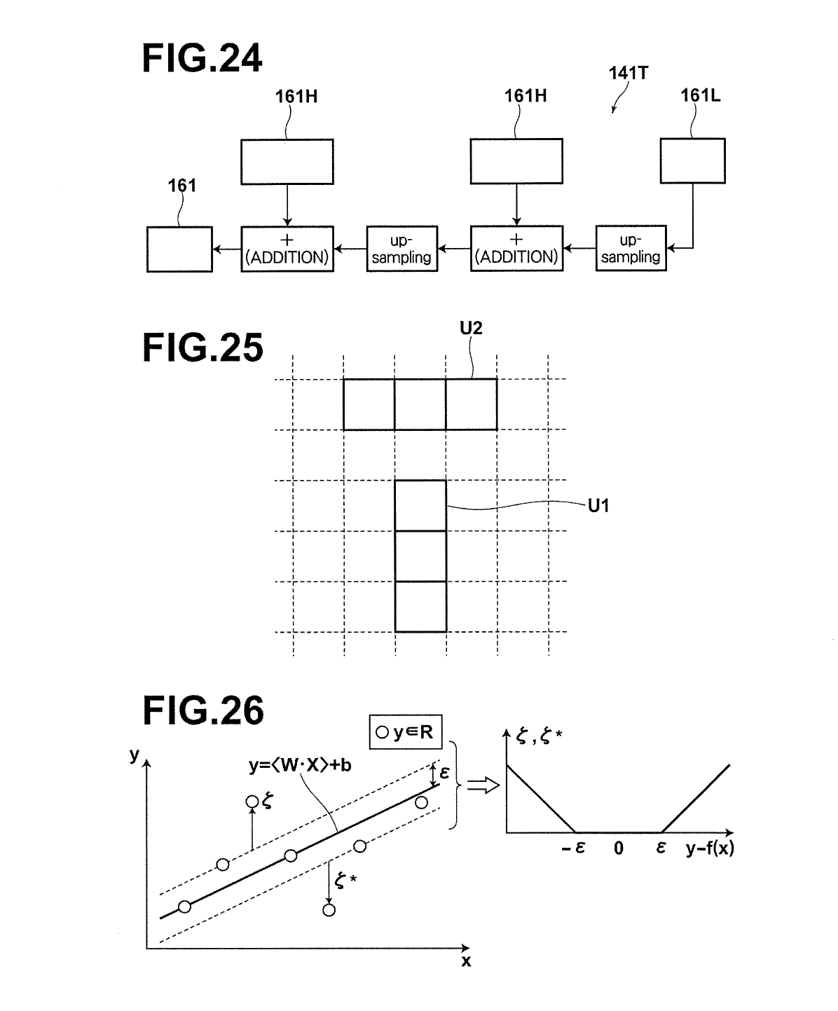

FIG. 24 illustrates up-sampling and addition in the image composition filter.

The image composition filter 141T obtains the diagnostic radiation image 161 by repeating up-sampling and addition in the order of low frequency range diagnostic target radiation image 161L intermediate frequency range diagnostic target radiation image 161M, and high frequency range diagnostic target radiation image 161H, as illustrated in FIG. 24.

That is, an image is obtained by adding an image obtained by up-sampling the low frequency range diagnostic target radiation image 161L to the intermediate frequency range diagnostic target radiation image 161M, and the diagnostic target radiation image 161 is obtained by adding an image obtained by up-sampling the obtained image to the high frequency diagnostic target image 161H.

The input characteristic amount in the regression model training will now be described in detail. FIG. 25 illustrates example regions forming the characteristic amount.

The characteristic amount may be a pixel value itself in the radiation images of the respective spatial frequency ranges, or may be that obtained by performing particular filtering thereon. For example, as illustrated in FIG. 25, the average pixel value in the region U1 or U2 including three adjacent pixels in the vertical or horizontal direction of an image of a particular spatial frequency range may be used as a new characteristic amount. Further, a wavelet conversion may be performed and the wavelet coefficient may be used as the characteristic amount. Still further, a pixel across a plurality of frequency ranges may be used as the characteristic amount.

Next, contrast normalization performed in the regression model training will be described.

A standard deviation is calculated for the pixel value of each of the pixels included in the sub-window Sw′ (FIG. 22) of each frequency range image. The pixel values of the frequency range image are multiplied by a coefficient so that the standard deviation corresponds to a predetermined target value.

I′=I×(C/SD)

where, I is the pixel value of the original image, I′ is the pixel value after contrast normalization, SD is the standard deviation of the pixels within the sub-window Sw′, and C is the target value (predetermined constant) of the standard deviation.

The sub-window Sw′ is scanned over the entire region of each of the radiation images, and for all of the sub-windows that can be set on each image, the normalization is performed by multiplying the pixel values within the sub-windows by a predetermined coefficient such that the standard deviation is brought close to the target value.

As a result of the normalization, the magnitude of the amplitude (contrast) of each spatial frequency range image is aligned. This reduces image pattern variations in the radiation images of the respective spatial frequency ranges inputted to the teacher trained filter 141, which provides the advantageous effect of improving the estimation accuracy for the bone portion.

In the step of training the teacher trained filter, which is a non-linear filter, the contrast normalization is performed on the high energy image, and the coefficient used is also used for multiplying the bone portion image without image quality degradation. Training samples are provided from pairs of normalized high energy images and bone portion images to train the non-linear filter.

In the step of estimating the diagnostic target radiation image mainly representing the bone portion of a diagnostic target subject, the contrast normalization is performed on the high energy image to be inputted, and pixel values of normalized images of the respective spatial frequency ranges are inputted to the teacher trained filter. The output value of the teacher trained filter is multiplied by the inverse of the coefficient used in the normalization, and the result is used as the estimated value of the bone portion.

As for the method for transforming a single image into a plurality of images of different spatial frequency ranges from each other, then generating a plurality of processed images of different spatial frequency ranges from each other by performing image processing on each of the transformed images, and obtaining a single processed image by combining the plurality of processed images as described above, any of various known methods may be used.

Next, support vector regression (regression by support vector machine (SVR)) will be described. FIG. 26 illustrates how to obtain an approximate function by support vector regression. For a problem of training a function for approximating a real value y which corresponds to d-dimensional input vector x, first considering a case in which the approximate function is linear.

f(x)= [symbol] w·x [symbol] +b w,xεR^{d},bεR (11)

In the ε-SVR algorithm proposed by Vapnik, a value of “f” for minimizing the following loss function is obtained.

For details of the ε-SVR algorithm proposed by Vapnik, refer to “An Introduction to Support Vector Machines and other kernel-based learning methods”, by Nello Cristianini and John Shawe-Taylor, Cambridge University Press 2000, UK, pp. 110-119.

$$Minimization \frac{1}{2} 〈 w \cdot w 〉 + C \cdot {R}_{emp} [ f ] \qquad ( 12 )$$

The <w·w> is the term representing complexity of the model for approximating data, and Rₑₘₚ[f] may be expressed like the following.

$${R}_{emp} [ f ] = \frac{1}{l} {\sum }_{i = 1}^{l} {\vert {y}_{i} - f ( {x}_{i} ) \vert}_{ɛ} = \frac{1}{l} {\sum }_{i = 1}^{l} ( {ξ}_{i} + {ξ}_{i}^{*} ) \qquad ( 13 )$$

where, |y−f(x)|ε=max{0, |y−f(x)|−ε}, indicating that an error smaller than ε is disregarded. ξ and ξ are the moderators that allow errors exceeding ε in the positive and negative directions respectively. C is the parameter for setting a tradeoff between the complexity of the model and moderation of the constraint.

The main problem described above is equivalent to solving the following dual problem, and from the nature of the convex quadratic program problem, a global solution may be invariably obtained.

$$Maximization {\sum }_{i = 1}^{l} {y}_{i} {α}_{i} - ɛ {\sum }_{i = 1}^{l} \vert {α}_{i} \vert - \frac{1}{2} {\sum }_{i , j = 1}^{l} {α}_{i} {α}_{j} 〈 {x}_{i} \cdot {x}_{j} 〉 \\ Condition {\sum }_{i = 1}^{l} {α}_{i} = 0 , - C \leq {α}_{i} \leq C , i = 1 , … , l . \qquad ( 14 )$$

The regression model obtained by solving the problem is expressed like the following.

$$f ( x ) = {\sum }_{i = 1}^{l} {α}_{i} 〈 {x}_{i} \cdot x 〉 + b \qquad ( 15 )$$

This function is a linear function. In order to extend it to a nonlinear function, it is only necessary to project the input x onto a higher order characteristic space Φ(x) and to regard the vector Φ(x) in the characteristic space as the input x(x→Φ(x)). In general, the projection onto a higher order space accompanies largely increased amount of calculations. But, replacement of an inner product term appearing in the formula to be optimized with a kernel function that satisfies the relationship of K(x, y)=<Φ(x), Φ(y)> may provides, with the input order calculations, the same calculation result as that obtained after projecting to a higher order space. As for the kernel function, RBF kernel function, polynomial kernel, or sigmoid kernel may be used.

Note that AdaBoost or the like may be used in the training of discrimination other than the support vector machine (SVM).

The number of discrimination classes is not limited to two classes, such as bone portion and region other than the bone portion, posterior rib and inbetween ribs, and the like, but may be three classes of posterior rib, inbetween ribs, and clavicle, or more than three classes including clavicle.

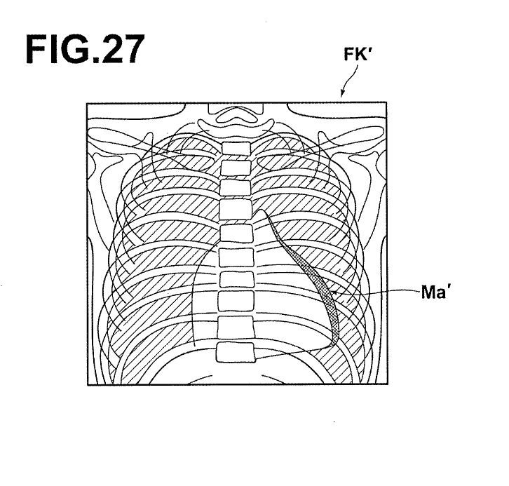

FIG. 27 illustrates a motion artifact produced in a bone portion image representing a chest.

As illustrated in FIG. 27, a motion artifact Ma′ may sometimes be produced according to heartbeat in a bone portion image FK′ representing an adult female chest, which is an energy subtraction image formed by a weighted subtraction using a high energy image and a low energy image obtained by radiography with radiations having different energy distributions from each other. Such motion artifact needs to be removed from the radiation image and may be removed in the following manner. That is, with the motion artifact Ma′ as the particular region described above, forming a radiation image with the motion artifact Ma′ highlighted by passing through the teacher trained filter, and subtracting so generated radiation image from the bone portion image FK′, thereby a bone portion image removed of the motion artifact Ma′ may be generated.

As described above, the particular region may be regarded as a region changed its position between the high energy image and low energy image obtained at different timings with each other. Further, the highlighted particular region described above may be an unnecessary region (defective region). In such a case, a radiation image representing the unnecessary region may be subtracted from a radiation image including both a necessary region and the unnecessary region to obtain a desired radiation image removed of the unnecessary region and including only the necessary region.

Where the teacher image of each of the subjects is obtained by radiography using a radiation dose greater than that used for obtaining each of the input radiation images, the radiation dose irradiated onto a single subject may exceed an acceptable value. By restricting the sum of radiation doses irradiated onto the subject during a predetermined time period, however, the radiography of the subject for obtaining the teacher image may be performed using a high radiation dose.

As illustrated in FIGS. 14 and 15, the radiation image processing apparatus 119 for implementing the radiation image processing method of the present invention includes: a filter obtaining section Mh11 (FIG. 14) for obtaining the teacher trained filter 140 trained using an input radiation image 111 constituted by a training subject image 111H, which is a plain radiation image representing an adult male chest obtained by plain radiography 109 of each of a plurality of adult male chests 1P, which are subjects of the same type, and a training region identification image 111C representing the boundary Pc between the bone portion Px, which is a particular region of the chest 1P, and the other region Po different from the bone portion Px obtained by performing a boundary extraction operation 112 on the subject image 111H and a teacher radiation image 133 having less image quality degradation than the subject image 111H and representing the bone portion Px, which is the particular region of the subject 1P, highlighted obtained by radiography of each of the chests 1P, with the input image 111 as the target and the teacher radiation image as the teacher; a same type image generation section Mh12 (FIG. 15) for generating a radiation image 121, which is the same type as the input radiation image 111, by performing plain radiography 120 of a diagnostic target chest 3P, which is a given subject of the same type as the subject 1P; and a region-enhanced image forming section Mh13 (FIG. 15) for forming a diagnostic radiation image with the bone portion Px of the given chest 3P highlighted by inputting the diagnostic target radiation image 121 to the teacher trained filter 140.

The operation of the radiation image processing apparatus 119 is identical to the radiation image processing method already described, so that it will not be elaborated upon further here. Note that each of the images used in the filter obtaining section Mh11, same type image generation section Mh12, and region-enhanced image forming section Mh13 may be either an image itself or image data representing the image.

The teacher trained filter is not a filter trained with respect to each of the small regions, but provided only one type for each frequency range and all of the small regions are processed by the single filter. The training method of the filter is that training samples are extracted from various small regions of a single (or small number) radiation image and the multitudes of samples are treated at the same time as amass. That is, training samples formed of, for example, around clavicles of Mr. A, around lower side of the clavicles of Mr. A, around the contour of the ribs of Mr. A, around the center of the ribs of Mr. A, and the like are learned at a time. Further, the characteristic amount for filter input is 25 pixels, but the teacher which is an output corresponding to the 25 pixels is not 25 pixels but a single pixel in the center of the small region.

Further, a program for performing the function of the radiation image processing apparatus of the present invention may be installed on a personal computer, thereby causing the personal computer to perform the operation identical to that of the embodiment described above. That is, the program for causing a computer to perform the radiation image processing method of the embodiment described above corresponds to the computer program product of the present invention.

1-25. (canceled)

26. A radiation image processing method comprising the steps of:
providing, with respect to each of a plurality of subjects of the same type, an input radiation image constituted by any one of (i) a high energy image and a low energy image obtained by radiography of each subject with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images;
providing, with respect to each of the subjects, a teacher radiation image, obtained by radiography of each subject, having less image quality degradation than the input radiation image of the subject and representing the subject with a particular region thereof highlighted;
obtaining a teacher trained filter through training using each input radiation image representing each subject as input and the teacher radiation image corresponding to the subject as the teacher;
obtaining, thereafter, a radiation image of the same type as the input radiation image for a given subject of the same type as the subjects; and
inputting the radiation image of the given subject to the teacher trained filter to form a radiation image of the given subject compensated for image quality degradation with a region thereof corresponding to the particular region highlighted.

27. The radiation image processing method of claim 26, wherein the radiation dose used in radiography for generating the teacher radiation image is greater than the radiation dose used in the radiography for generating the input radiation image.

28. The radiation image processing method of claim 26, wherein the teacher radiation image is an image formed by a weighted subtraction using a high energy image and a low energy image obtained by radiography with radiations having different energy distributions from each other.

29. The radiation image processing method of claim 26, wherein the particular region is a region having a particular radiation attenuation coefficient different from that of the other region.

30. The radiation image processing method of claim 26, wherein the subject is a living tissue and the particular region is a bone portion or a soft tissue portion of the living tissue.

31. The radiation image processing method of claim 26, wherein:
the particular region is a bone portion; and
a soft tissue portion of the given subject is generated by subtracting the radiation image of the given subject compensated for image quality degradation with the bone portion of the given subject highlighted formed by the radiation image processing method from the high energy image or low energy image representing the given subject.

32. The radiation image processing method of claim 26, wherein:
the particular region is a region of the subject that changed its position between the high energy image and low energy image; and
the radiation image of the given subject compensated for image quality degradation with the bone portion of the given subject highlighted formed by the radiation image processing method is subtracted from the bone portion image or soft tissue portion image representing the given subject to eliminate a motion artifact component produced in the bone portion image or soft tissue portion image.

33. The radiation image processing method of claim 26, wherein:
the training for obtaining the teacher trained filter is performed with respect to each of a plurality of spatial frequency ranges different from each other;
the teacher trained filter is a filter that forms the radiation image of the given subject with respect to each of the spatial frequency ranges; and
each of the radiation images formed with respect to each of the spatial frequency ranges is combined with each other to obtain a single radiation image.

34. A radiation image processing apparatus comprising:
a filter obtaining means for obtaining a teacher trained filter through training using an input radiation image provided with respect to each of a plurality of subjects of the same type, which is constituted by any one of (i) a high energy image and a low energy image obtained by radiography of each of the subjects with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images, and a teacher radiation image provided with respect to each of the subjects, obtained by radiography of each subject, having less image quality degradation than the input radiation image of the subject and representing the subject with a particular region thereof highlighted, wherein each input radiation image representing each subject is used as input, while the teacher radiation image corresponding to the subject is used as the teacher;
a same type image generation means for generating a radiation image of the same type as the input radiation image for a given subject of the same type as the subjects; and
a region-enhanced image forming means for inputting the radiation image of the given subject to the teacher trained filter to form a radiation image of the given subject compensated for image quality degradation with a region thereof corresponding to the particular region highlighted therein.

35. A computer readable medium on which is recorded a program for causing a computer to perform a radiation image processing method comprising the steps of:
obtaining a teacher trained filter through training using an input radiation image provided with respect to each of a plurality of subjects of the same type, which is constituted by any one of (i) a high energy image and a low energy image obtained by radiography of each of the subjects with radiations having different energy distributions from each other (ii) the high energy image and one or more types of energy subtraction images formed by a weighted subtraction using the high and low energy images, (iii) the low energy image and the one or more types of energy subtraction images, and (iv) only the one or more types of energy subtraction images, and a teacher radiation image provided with respect to each of the subjects, obtained by radiography of each subject, having less image quality degradation than the input radiation image of the subject and representing the subject with a particular region thereof highlighted, wherein each input radiation image representing each subject is used as input, while the teacher radiation image corresponding to the subject is used as the teacher;
generating a radiation image of the same type as the input radiation image for a given subject of the same type as the subjects; and
inputting the radiation image of the given subject to the teacher trained filter to form a radiation image of the given subject compensated for image quality degradation with a region thereof corresponding to the particular region highlighted.

36. A radiation image processing method comprising the steps of:
providing, with respect to each of a plurality of subjects of the same type, an input radiation image constituted by a region identification image representing a boundary between a particular region and the other region different from the particular region of each subject and a subject image representing each subject which are obtained by radiography of each subject;
providing, with respect to each of the subjects, a teacher radiation image representing each subject with the particular region thereof highlighted obtained by radiography of each subject;
obtaining a teacher trained filter through training using each input radiation image representing each subject as input and the teacher radiation image corresponding to the subject as the teacher;
obtaining, thereafter, a radiation image of the same type as the input radiation image for a given subject of the same type as the subjects; and
inputting the radiation image of the given subject to the teacher trained filter to form a radiation image of the given subject with a region thereof corresponding to the particular region highlighted.

37. The radiation image processing method of claim 35, wherein the radiation dose used in the radiography for generating the teacher radiation image is greater than the radiation dose used in the radiography for generating the subject image.

38. The radiation image processing method of claim 35, wherein the teacher radiation image is an image formed by a weighted subtraction using a high energy image and a low energy image obtained by radiography with radiations having different energy distributions from each other.

39. The radiation image processing method of claim 35, wherein the input radiation image is an image formed by a weighted subtraction using a high energy image and a low energy image obtained by radiography with radiations having different energy distributions from each other.

40. The radiation image processing method of claim 35, wherein the subject image is a plain radiation image obtained by plain radiography.

41. The radiation image processing method of claim 35, wherein the particular region is a region having a particular radiation attenuation coefficient different from that of the other region.

42. The radiation image processing method of claim 35, wherein the subject is a living tissue, and the particular region includes at least one of a bone portion, rib, posterior rib, anterior rib, clavicle, and spine.

43. The radiation image processing method of claim 35, wherein the subject is a living tissue and the other region different from the particular region includes at least one of a lung field, mediastinum, diaphragm, and in-between ribs.

44. The radiation image processing method of claim 35, wherein the subject is a living tissue and the particular region is a bone portion or a soft tissue portion of the living tissue.

45. The radiation image processing method of claim 35, wherein:
the training for obtaining the teacher trained filter is performed with respect to each of a plurality of spatial frequency ranges different from each other;
the teacher trained filter is a filter that forms the radiation image of the given subject with respect to each of the spatial frequency ranges; and
each of the radiation images formed with respect to each of the spatial frequency ranges is combined with each other to obtain a single radiation image.

46. A radiation image processing apparatus comprising:
a filter obtaining means for obtaining a teacher trained filter through training using an input radiation image provided with respect to each of a plurality of subjects of the same type, which is constituted by a region identification image representing a boundary between a particular region and another region different from the particular region of each subject obtained by radiography of each subject and a subject image representing each subject, and a teacher radiation image, provided with respect to each of the subjects, representing each subject with the particular region thereof highlighted obtained by radiography of each subject, wherein each input radiation image representing each subject is used as input, while the teacher radiation image corresponding to the subject is used as the teacher;
a same type image generation means for generating a radiation image of the same type as the input radiation image for a given subject of the same type as the subjects; and
a region-enhanced image forming means for inputting the radiation image of the given subject to the teacher trained filter to form a radiation image of the given subject with a region thereof corresponding to the particular region (Px) highlighted therein.

47. A computer readable medium on which is recorded a program for causing a computer to perform a radiation image processing method comprising the steps of:
obtaining a teacher trained filter through training using an input radiation image provided with respect to each of a plurality of subjects of the same type, which is constituted by a region identification image representing a boundary between a particular region and the other region different from the particular region of each subject obtained by radiography of each subject and a subject image representing each subject, and a teacher radiation image, provided with respect to each of the subjects, representing each subject with the particular region thereof highlighted obtained by radiography of each subject, wherein each input radiation image representing each subject is used as input, while the teacher radiation image corresponding to the subject is used as the teacher;
generating a radiation image of the same type as the input radiation image for a given subject of the same type as the subjects; and
inputting the radiation image of the given subject to the teacher trained filter to form a radiation image of the given subject with a region thereof corresponding to the particular region highlighted.
